(19) United States
(12) Patent Application Publication
(10) Pub. No.: US 2006/0200480 A1
(43) Pub. Date: Sep. 7, 2006

(54) System and method for using product identifiers

(76) Inventors: David N. Harris, Sonora, CA (US); Sonja J. Harris, Sonora, CA (US); Gregory P. Gibson, Three Rivers, MI (US); Larry E. Henneman JR., Three Rivers, MI (US)

Correspondence Address: Henneman & Saunders, 714 W. Michigan Ave., Three Rivers, MI, 49093, US

(21) Appl. No.: 11/069,764

(22) Filed: Mar. 1, 2005

(51) Int. Cl. G06F 17/00

(52) U.S. Cl. 707/101

(57) ABSTRACT

A novel method for using product identifiers includes capturing a product identifier identifying a product, selecting one of a plurality of queries, transmitting the product identifier and the selected query to a data provider, and receiving a response to the selected query from the data provider. The method is performed on a personal data device (e.g., a camera phone, PDA, tablet PC et.), which includes a network interface, a scanner operative to capture the product identifier, a user interface operative to receive the query selection, and an application program interface operative to associate the product identifier and the selected query, transmit the product identifier and the selected query to the data provider via the network interface, and to receive the response to the identifier and query from the data provider via the network interface. A method for the data providers to use the product identifiers is also disclosed, and includes receiving a request from a consumer including a unique product identifier and data indicative of the type of information requested, retrieving the type of requested information associated with the particular product from a database, and transmitting the retrieved information to the consumer. The data provider includes a database associating the product identifiers with information corresponding thereto, and means for the providing the associated information to the requesting consumer.

### BACKGROUND OF THE INVENTION

1. Field of the Invention

This invention relates generally to the use of product identifiers, and more particularly to a system and method of using product identifiers captured by a personal data device to facilitate rapid information retrieval and electronic commerce. Even more particularly, this invention relates to a portable device that can capture product identifiers at convenient locations and immediately retrieve information associated with the identified product.

2. Description of the Background Art

Since the introduction of the Internet, society has become accustomed to having information readily available to their home and/or laptop computer. As a result, society has become increasingly captivated by the convenience and price competition now available over the Internet. For example, many people routinely employ search engines in order to quickly research information about a product or service they are interested in. Competitive shoppers are also frequent information gatherers on the internet, searching online stores for the best available prices or for locations at which they can purchase a desired product.

There are several drawbacks, however, to gathering information and/or shopping on the Internet. First, the information available over the Internet is generally accessible only from a home computer or with a laptop via a public wireless access point. Moreover, a particular product must be researched via a search engine and/or through “hit-or-miss” shopping at particular websites. Both of these procedures can be time consuming. Although some mobile telephones offer some limited Internet services (e.g., e-mail retrieval, etc.), most are not yet acceptable as a web browsing research tool. Even if portable personal data devices (e.g., cellular telephones, personal data assistants, tablet PCs, etc.) can be used to browse the Internet, most users will not want to spend a substantial amount of time browsing the Internet with such devices due to cellular airtime charges, limited battery life, slow connection speeds, etc. of such devices. Therefore, someone wanting information about a product or wishing to comparison shop while browsing in public will have to wait until returning to their computer to do so, and will be burdened by the generally time-consuming Internet comparison shopping methods described above.

Like the Internet, independent information databases can also store a vast amount of information, but are not readily accessible to the public. For example, information relating to drug interactions may be accessible on the Internet, but such information may be difficult and/or time consuming to locate. The search for such information can also be confusing to a lay person due to the various generic and trade names used to describe different drugs. Therefore, browsing the web with a cell phone would be a particularly unsatisfactory method of identifying drug interactions when, for example, shopping for over-the-counter medicine at the drug store. Similarly, browsing the Internet for information on food products, while grocery shopping is equally unacceptable.

One attempt to address the problems of the prior art is provided in United States Patent Application Publication No. 2002/0023959 (Miller et al.), published Feb. 28, 2002. According to Miller et al., a user can scan a bar code, download the barcode from the scanning device (when the user gets home), then submit the bar code to a server via the Internet. The user is then provided with a portal page including various graphics, advertisements, links and other data, from which the user can navigate to view information concerning an item. Thus, the user must return home to use the system, instead of being provided with the information immediately while out shopping. Indeed, the banners, advertisements and so forth used in Miller et al. would further frustrate a shopper attempting to browse a web page on a portable device such as a cell phone. Further, apart from customizing and/or navigating a user's portal web page, a user has no control over the type of information provided in response to submission of the bar code.

What is needed therefore is a system and method for electronically identifying a product and quickly gathering information about the product. What is also needed is a system and method for providing and helpfully displaying the gathered information to the requester on their personal data device, without requiring the user to return home. What is also needed is a system and method for providing the type of information desired by the user.

### SUMMARY

The present invention overcomes the problems associated with the prior art by providing a system and method that facilitates rapid information retrieval by scanning a product identifier with a personal data device and using the product identifier to search a database associated with a data provider.

A novel method for using product identifiers with a personal data device includes capturing a product identifier associated with a product, receiving a user's selection of one of a plurality of queries, transmitting the product identifier and the selected query to a data provider, and receiving a response to the selected query from the data provider. There are several methods for capturing a product identifier including, but not limited to, scanning a barcode, optically reading a barcode (e.g., via digital camera) and decoding the barcode, receiving a radio signal identifying the product from an RFID device, and entering the product identifier by hand. In addition, the product identifier can be transmitted directly to the data provider or via a third party, such as through a cellular telephone company.

Several types of queries used to retrieve particular product information are disclosed. These queries include a retail information query, a drug interaction query, a food allergy query, a food nutrition query, and a recipe query. Transmitting a retail information query with a product identifier allows a consumer to retrieve product information associated with retailers selling an identified product. Transmitting a drug interaction query with one or more drug identifiers (i.e., a product identifier associated with a drug product) allows the consumer to retrieve drug interaction information associated with the identified drug(s). Transmitting a food allergy query with a food identifier (a product identifier associated with a food product) allows the consumer to retrieve allergy information (may be specific to the user) associated ingredients of the identified food product. Transmitting a food nutrition query with one or more food identifiers allows the consumer to retrieve nutrition information (diet points/serving, carbohydrates/serving, etc.) associated with the identified food(s). As yet another example, transmitting a recipe query with a food identifier allows the consumer to retrieve recipes including food products identified by the food identifier(s). Optionally, the queries described above can include one or more parameters to limit and/or define the information received in response to the query.

In a particular method, wherein the retail information query is selected, receiving the response to the query includes receiving retail information data associated with at least one retailer selling a particular identified product. Optionally, the current geographical location of the system/user can be transmitted with the retail information query, and the retail information report contains data associated with retailers within a predetermined distance of the geographical location. A more particular method includes selecting a purchase request and transmitting the product identifier(s) and the purchase request to a particular retailer (optionally via the data provider) in order to purchase the identified product from the retailer.

In another particular method, wherein the drug interaction query is selected, receiving the response to the query includes receiving drug interaction data associated with at least one drug interaction between the identified drug and at least one other drug associated with the consumer (e.g., by a record stored by the data provider). Optionally, the user can transmit storage instructions to cause the data provider to store a record associating the drug identified by the drug identifier with the user. A more particular method includes capturing a plurality of drug identifiers, transmitting the drug identifiers and the drug interaction query to the data provider, and receiving a response including a drug interaction report having data therein associated with at least one drug interaction between any combination of the submitted drug identifiers.

In another particular method, wherein the food allergy query is selected, receiving the response to the query includes receiving data including at least one ingredient identifier associated with an ingredient in the food product, the ingredient being associated with an allergy of the user (e.g., by a record stored by the data provider). A more particular method allows a consumer to record pre-identified allergy identifiers by capturing at least one allergy ingredient identifier and transmitting storage instructions with the allergy ingredient identifier(s) causing the data provider to store a record associating the allergy ingredient(s) with the consumer.

In another particular method, wherein the food nutrition query is selected, receiving the response to the query includes receiving a nutrition report having nutrition information stored therein associated with a food product identified by the food identifier. In the case of a recipe query, a particular method includes receiving at least one recipe including a food product identified by a food identifier.

In any of the above-described methods, the responses to the queries can be displayed to the consumer. Optionally, the received data can be sorted before being displayed. Accordingly, a more particular method includes sorting the information according to a sort criteria (e.g., by price and/or location) selected by the consumer. Also optionally, the method includes a step of storing the response from the data provider in a local database of the personal data device for later retrieval. The local database on the personal data device associates product information and product identifiers, such that the personal data device can perform at least some limited functions of the data provider if so desired. Stated another way, the step of transmitting a product identifier and a query to the data provider can be achieved by transferring at least a portion of the database from the data provider to the local device and querying the database on the local device.

A system (e.g., a camera phone, PDA, tablet PC, etc.) for using product identifiers is also disclosed. The system includes a network interface, a scanner (e.g., a digital camera, a radio receiver, etc.) operative to capture the product identifier, a user interface operative to receive the query selection from the user, and a control module operative to associate the product identifier and the selected query, to transmit the product identifier and the selected query to the data provider, and to receive the response to the identifier and query from the data provider. In a particular embodiment, the system includes a position detector operative to detect the geographical position of the mobile system. The user interface includes a display for displaying graphical data to the consumer.

An application program interface (API) provides communication between the control module of the user system and the database of the data provider. The application program interface defines the commands (e.g., to write a record to the database), queries (e.g., drug interaction queries), and parameters that may be submitted to the database, and also defines the structure of the response returned by the database. An information formatter/sorter, responsive to a user selected sort criteria, is operative to sort the product information according to the sort criteria. In another embodiment, the application program interface defines an interface to transmit a subscriber identifier uniquely identifying a consumer to the data provider.

In a particular embodiment, the application program interface includes a purchase request interface operative to associate a purchase request query with a product identifier and a retailer identifier responsive to instruction from the consumer. The product request interface is then operative to transmit a purchase request and the product identifier to the retailer identified by the retailer identifier. Optionally, the purchase request query can be transmitted to the retailer via the data provider.

In another particular embodiment, in the case of a food allergy query, the API defines a command whereby, responsive to instructions from a consumer, the control module can submit one or more allergy ingredient identifiers to be associated with the consumer. Responsive to receipt of the command, the data provider stores one or more records associating a unique consumer identifier with the submitted allergy ingredient identifiers.

A method for data providers to use product identifiers is also disclosed, and includes receiving a request (e.g., a database query) from a consumer including a unique product identifier and data indicative of the type of information requested, retrieving the type of requested information associated with the particular product from a database, and transmitting the retrieved information to the consumer. In addition, the consumer can be authenticated before the data provider accepts the request. The request can also contain a parameter to define the content of the retrieved data from the database.

In a particular method when the data provider receives a retail information request, the data provider is further operative to retrieve retailer information from its database including a retailer identifier, and transmit the retailer information to the consumer. In a more particular embodiment, the method includes receiving a geographical location of the consumer with the retail information request, and then retrieving retailer information only for retailers near the geographical location. Optionally, the method further includes a step of receiving a purchase request from the consumer for purchasing a particular product from a particular retailer after the retail information has been transmitted. The purchase request contains the product identifier and the retailer identifier such that the data center can retrieve credit data associated with the consumer from the database, and transmit a transaction request to the retailer including the product identifier and the consumer's credit data.

In a particular method when the data provider receives a drug interaction request including at least one drug identifier, the method further includes retrieving information from the database for each combination of the at least one drug and at least one pre-identified drug associated with the consumer in the database, and transmitting the retrieved interaction information for each combination to the consumer. Optionally, a more particular method includes the step of receiving storage instructions from the consumer to store the drug associated with the drug identifier in the database as a pre-identified drug associated with the consumer. Finally, in the case that the drug interaction request includes a plurality of drug identifiers, an alternate more particular method includes retrieving interaction information between each combination of the drugs identified in the interaction request, and transmitting interaction information for each combination of drugs having an interaction to the consumer.

In another particular method when the data provider receives a food allergy request including at least one food product identifier, the method includes retrieving the ingredient identifiers associated with the ingredients contained in the food product and attempting to match the ingredient identifiers in the food product with pre-identified allergy ingredient identifiers associated with the consumer, and then transmitting any allergy ingredient identifiers associated with allergy ingredients in the food product to the consumer. A more particular method includes the steps of receiving an allergy ingredient storage request including at least one allergy ingredient identifier, and storing the allergy ingredient identifier in the database as a pre-identified allergy ingredient identifier associated with the consumer.

In some cases (e.g., pure food items) the allergy ingredient will be the food product itself. For example, eggs, peanuts, etc. are not considered to have constituent “ingredients.” Rather, the only ingredient in an egg is egg. Thus, the food product is the same as the allergy ingredient.

In another particular method when the data provider receives a food nutrition request including at least one food product identifier, the method includes retrieving nutrition information associated with the food product. Finally, in another particular method when the data provider receives a recipe request including at least one food product identifier, the method includes retrieving at least one recipe having the food product as an ingredient.

The consumer may wish to update information associated with him/her with the data provider. In such a case, a particular method includes the steps of receiving an information update request from the consumer, associating the request with the consumer, and storing the information associated with the consumer in the database. Such information can be submitted to the data provider by, for example, form or query.

In addition, the product data contained in the database of the data provider must be updated from time to time. A particular method for updating database information includes receiving product update information from a product vendor including a unique vendor identifier and at least one unique product identifier, retrieving data from the database corresponding with the product and the vendor, and updating the retrieved information with product update information. Optionally, the data is updated by simply writing new records to the database, without altering any existing records. The product update information can be received from the vendor via a query of the vendor's database, a database form, or any other type of data template.

A system for a data provider to use product identifiers is also disclosed and includes a database associating unique product identifiers with information corresponding to the product, a network interface to receive a request from a consumer (i.e., a user) including at least one product identifier and data indicative of the type of information requested, and a consumer application program interface (API) operative to submit the request to the database, retrieve the requested information from the database, and transmit a response to the request via the network interface. Optionally, the network interface is operative to receive the request from the consumer via a third party, such as a cellular telephone communications company.

The consumer API performs a variety of functions. For example, the API is operative to search for information based upon one or more particular parameters (e.g., price, geographical location, etc.) received with the request. Also, when the network interface receives an information update request (e.g., a query or form) from a consumer for updating their personal information, in a particular embodiment, the consumer API is operative to store the information associated with the consumer in the database, such that information is associated with the consumer via a unique consumer identifier. Also, the data provider may require authentication of the consumer's identity for security reasons. In such an embodiment, the consumer API is further operative to retrieve security information associated with the consumer from the database, and verify the security information submitted by the consumer in the request with the security information from database prior to submitting the request to the database.

In another particular embodiment, the system includes a retailer API for receiving a purchase request including a retailer identifier and a product identifier from the consumer, and is operative to transmit a transaction request to a credit company to effect purchase of the particular product. The transaction request includes the particular retailer identifier, the particular product identifier, and credit information retrieved from the database associated with the consumer.

In still another particular embodiment, the system includes a vendor API that is operative to receive product update information (e.g., via query or form) from a product vendor (i.e., a retailer) including a unique vendor identifier and at least one product identifier. The vendor API is then operative to retrieve data from the database corresponding to the product identifier and the vendor identifier, and update the retrieved information with the product update information. Optionally, the vendor API writes the updated data to the database without altering any existing data records.

Novel data structures, application program interfaces, and graphical user interfaces are also disclosed, and are considered to be part of the present invention.

### BRIEF DESCRIPTION OF THE DRAWINGS

The present invention is described with reference to the following drawings, wherein like reference numbers denote substantially similar elements:

FIG. 1 is a relational diagram showing the relationship between various functional components of the present invention;

FIG. 2 is a block diagram of a system for using product identifiers according to the present invention;

FIG. 3A shows a camera phone scanning a product identifier according to one embodiment of the present invention;

FIG. 3B shows the photograph of the product identifier taken by the camera phone of FIG. 3A;

FIG. 4 is a block diagram showing the flow of product information to a personal data device according to one embodiment of the present invention;

FIG. 5 shows example tables included in the database(s) maintained by the data providers of FIG. 2 according to one embodiment of the present invention;

FIG. 6 is a block system diagram of one of the data providers of FIG. 2 according to one embodiment of the present invention;

FIG. 7A is a diagram showing an example exchange of information between the personal data device of FIG. 2 and the product information database of FIG. 6 according to one embodiment of the present invention;

FIG. 7B is a block diagram showing an example exchange of information between a retailer of FIG. 2 and the product information database of FIG. 6 according to one embodiment of the present invention;

FIG. 8 is a block diagram illustrating the flow of data through a database interface according to one embodiment of the present invention;

FIG. 9 shows example tables included in a database maintained by a personal data device of FIG. 2 according to one embodiment of the present invention;

FIG. 10 is a block diagram of a personal data device for using product identifiers according to the present invention;

FIG. 11 is a flowchart summarizing one method of using product identifiers with a personal data device according to the present invention;

FIG. 12 is a flowchart summarizing one particular method for performing the fifth step of the flowchart of FIG. 11;

FIG. 13 is a flowchart summarizing another particular method for performing the fifth step of the flowchart of FIG. 11;

FIG. 14 is a flowchart summarizing one method for supplying product information according to the present invention;

FIG. 15 shows example tables included in a database maintained by a data provider of FIG. 2 according to an alternate embodiment of the present invention;

FIG. 16A shows a query used to request data from a database including the tables of FIG. 15;

FIG. 16B shows another query used to request data from a database including the tables of FIG. 15;

FIG. 17 shows a report generated from a database including the tables of FIG. 15 in response to the query of FIG. 16A or FIG. 16B;

FIG. 18 is a flowchart summarizing an alternate method of using product identifiers according to the present invention;

FIG. 19 is a flowchart summarizing an alternate method for supplying product information according to an alternate embodiment of the present invention;

FIG. 20 shows example tables included in a database maintained by a data provider of FIG. 2 according to an another alternate embodiment of the present invention;

FIG. 21 shows a query used to request data from a database including the tables of FIG. 20;

FIG. 22 shows a report generated from a database including the tables of FIG. 15 in response to the query of FIG. 21;

FIG. 23 is a flowchart summarizing a method of using product identifiers according to another alternate embodiment of the present invention;

FIG. 24 is a flowchart summarizing a method for supplying product information according to another alternate embodiment of the present invention;

FIG. 25 shows example tables included in a database maintained by a data provider of FIG. 2 according to another alternate embodiment of the present invention;

FIG. 26 shows a query used to request data from a database including the tables of FIG. 25;

FIG. 27 shows a report generated from a database including the tables of FIG. 25 in response to the query of FIG. 26;

FIG. 28 is a flowchart summarizing a method of using product identifiers according to another alternate embodiment of the present invention;

FIG. 29 is a flowchart summarizing a method for supplying product information according to another embodiment of the present invention;

FIG. 30 shows example tables included in a database maintained by a data provider of FIG. 2 according to another alternate embodiment of the present invention;

FIG. 31 shows a query used to request data from a database including the tables of FIG. 30;

FIG. 32 shows a report generated from a database including the tables of FIG. 30 in response to the query of FIG. 31;

FIG. 33 is a flowchart summarizing a method of using product identifiers according to another embodiment of the present invention;

FIG. 34 is a flowchart summarizing a particular method for supplying product information according to another embodiment of the present invention;

FIG. 35 shows a portion of a graphical user interface of the present invention;

FIG. 36 shows another portion of a graphical user interface of the present invention; and

FIG. 37 shows another portion of a graphical user interface of the present invention.

### DETAILED DESCRIPTION

The present invention overcomes the problems associated with the prior art, by providing a system and method facilitating rapid information gathering by scanning a product identifier with a personal data device. In the following description, numerous specific details are set forth (e.g., example database tables, credit companies, etc.) in order to provide a thorough understanding of the invention. Those skilled in the art will recognize, however, that the invention may be practiced apart from these specific details. In other instances, details of well known network and database programming practices (e.g., routine optimization, application coding, database maintenance, etc.) and components have been omitted, so as not to unnecessarily obscure the present invention.

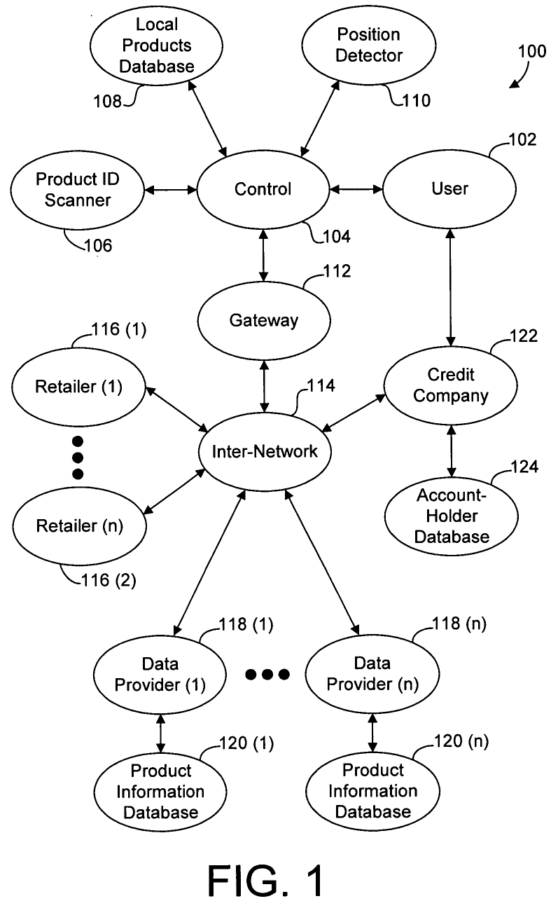

FIG. 1 is a relational diagram 100 showing the functional relationships between various components of the present invention. In the present embodiment, a user 102 interacts directly with a personal data device (e.g., a camera cellular phone, a personal data assistant (PDA), a tablet PC, etc.) via a control module 104. Control module 104 interacts with and generally controls other software and hardware components of the personal data device including, but not limited to, a product identifier (ID) scanner 106, a local products database 108, and a position detector 110. In addition, control module 104 communicates with a gateway 112 in order to communicate with remote data providers.

Control module 104 calls product ID scanner 106 to capture a product identifier (e.g., a UPC code, RFID tag, ISBN, etc.) associated with a product. Once captured, control module 104 is operative to retrieve information about the identified product from local products database 108, which can conceivably store many different kinds of information (e.g., price, location, ingredients, nutrition information, etc.) associated with the identified product. Position detector 110 monitors the geographical location of the personal data device (PDD) housing the above described modules, and makes the geographical information available to control module 104 upon request. For example, position detector 110 could be a global positioning system (GPS) receiver for triangulating the position of the PDD. As another example, position detector 110 could also triangulate the position of the PDD based on the signals received from various cellular telephone towers. Finally, user 102 provides input to control module 104 to facilitate/direct its various functions as described herein.

Gateway 112 serves as a third-party communications bridge between control module 104 of the PDD and an inter-network 114. Gateway 112 could, for example, be a cellular communications host, a wireless access point communicating with an internet service provider (ISP), or any other system or device that could provide communication between control module 104 and inter-network 114.

Inter-network 114 is a wide area network, such as the Internet. For simplicity of explanation, inter-network 114 will be assumed hereafter to be the Internet, however it should be noted that inter-network 114 could comprise any network that could perform the functions described herein with respect to Internet 114. Internet 114 provides a communications link between the various components of the present invention, including control module 104 of the PDD (e.g., via gateway 112), a plurality of product retailers 116(1-n), a plurality of data providers 118(1-n) each having a product information database 120(1-n), and a credit company 122.

Each of retailers 116(1-n) provide product information to one or more of data providers 118(1-n). It should be noted that retailers 116(1-n) can be any type of retailer or vendor, including, but not limited to, retail outlets, pharmaceutical companies, service companies, and food manufacturers. Each of data providers 118(1-n) organize and store the information received from retailers 116(1-n) in product information databases 120(1-n), wherein the stored product information is associated with a unique product identifier. Additionally, data providers 118(1-n) provide product information from databases 120(1-n) to the control module 104 of the PDD via internet 114 and gateway 112, responsive to receiving a product information request from control module 104, which includes a product identifier captured by product ID scanner 106.

Credit company 122 provides an optional means for purchasing a product from one of retailers 116(1-n) identified as a result of a product information request placed to one of data providers 118(1-n). For purchases, the credit information of user 102 would be transmitted to retailers 116(1-n) either from control module 104 or indirectly from one of data providers 118(1-n) via internet 114. The retailer 116 could then authorize the purchase with credit company 122 to effect payment for the item. Of course, other payment methods could be utilized instead or in addition to credit card payment.

The credit company 122 includes an account-holder database 124 that stores information associated with user 102 and any other users having credit accounts with credit company 122. Optionally, user 102 can request that transactions with credit company 122 be verified directly by user 102 for added security. In such a case, there are many verification methods and/or other safety features that could be employed, such as those described in co-pending U.S. patent application Ser. No. 09/617,361 entitled “System and Method for Verifying Commercial Transactions,” co-pending U.S. patent application Ser. No. 09/760,271 entitled “System and Method for Pre-Verifying Commercial Transactions,” and co-pending U.S. patent application Ser. No. 10/889,227 entitled “System and Method for Securing a Credit Account,” each of which is incorporated herein by reference.

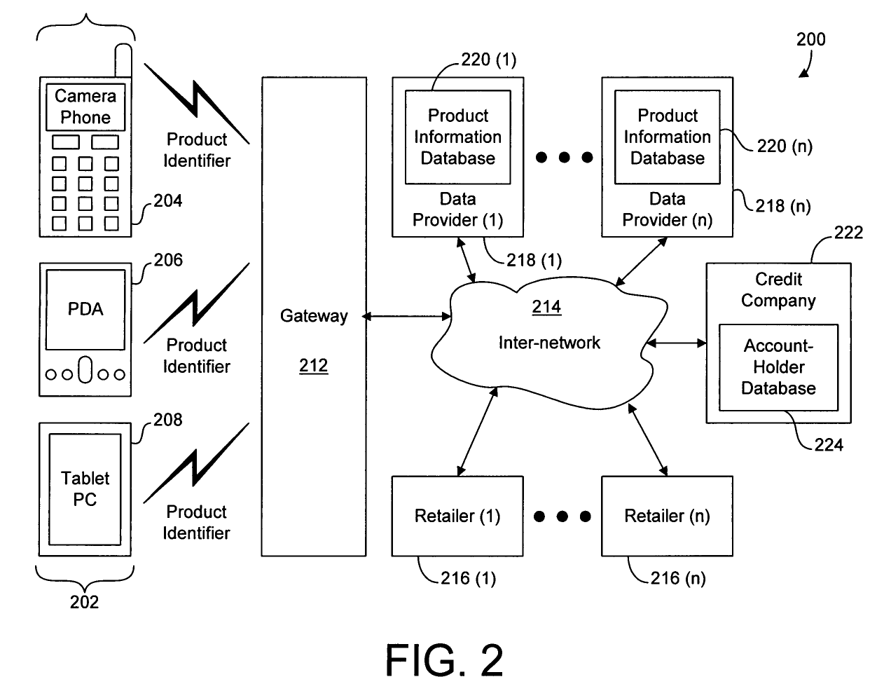

FIG. 2 is a block diagram of an example system 200 for using product identifiers according to the present invention. System 200 includes various examples of a personal data device (PDD) 202, including a cellular telephone 204 with a built-in camera, a personal data assistant (PDA) 206, and a tablet PC 208. System 200 also includes a gateway 212, an inter-network (Internet) 214, a plurality of product retailers 216(1-n), a plurality of data providers 218(1-n) each having an associated product information database 220(1-n), and a credit company 222 having an account-holder database 224.

PDDs 202 are capable of capturing product identifiers and decoding the information stored in the identifier in a variety of ways. For example, camera phone 204 utilizes its camera to take pictures of product identifiers, for example bar codes, and then uses pattern recognition software to convert the image into electronic data representing the product identifier. PDA 206 and tablet PC 208 can also be equipped with a camera and software for decoding a barcode, or any other encoded graphic image. As another example, any of the PDDs 202 can be equipped with a conventional barcode scanner, an antenna capable of discerning radio frequency identification (RFID) tags, or any other type of transducer for capturing a product identifier. In the simplest case the identifier (e.g., a UPC) can be simply entered into PDD 202 via a menu driven display, keypad, or some other means. Each PDD 202 is also equipped with an antenna (not shown on PDA 206 and tablet PC 208) for wirelessly transmitting electronic data (e.g., a product information request) to gateway 212, for example, data representing decoded product identifiers and any other necessary information. Many types of wireless communication methods can be used, including but not limited to cellular data transmission and transmissions conforming to any of the 802.11 a/b/g wireless transmission standards.

Gateway 212 receives electronic data transmitted from PDDs 202 and transmits the data to internet 214. Gateway 212 is for example, a cellular provider offering a product information service of the present invention to its cellular subscribers. In another embodiment, gateway 212 is a wireless network access point in a cafe or shopping center.

Internet 214 is a wide area network that provides intercommunication between gateway 212, retailers 216(1-n), data providers 218(1-n), and credit company 222. Each of retailers 216(1-n) sell products and provide product and other information (e.g., price, quantity, retailer location, etc.) to one or more of data providers 218(1-n). Data providers 218(1-n) store the product information received from retailers 216, via internet 214, each in their respective databases 220(1-n). Responsive to receiving a product information request (a query) from one of PDDs 202 via internet 214, one or more of data providers 218(1-n) is operative to retrieve corresponding product information from their product information database 220(1-n) and transmit the product information back to PDD 202, via internet 214 and gateway 212.

For example, PDD 202 might send a product information request including a product identifier to one or more of data providers 218(1-n) requesting the price of a product offered by different retailers. The data provider 218 is then able to identify the product by the product identifier included in the received product information request, determine from database 220 which of retailers 216(1-n) sell the product and the associated prices of the product, and report the retailer and price information to the PDD 202 via internet 214. Depending on the particular query, other types of information can be sent as well, including but not limited to retailer location, quantity on hand, and contact information.

Credit company 222 allows a user (e.g., user 102) to make a purchase via one of PDDs 202. Credit company 222 includes an account-holder database 224 which stores credit account information associated with users (e.g., user 102) of PDDs 202. A credit purchase can be effected by user 102 via a PDD 202 in several ways. First, after receiving a product information report from a data provider 218, the user can instruct the PDD 202 to make a credit purchase directly with a retailer 216. Alternately, the data provider 218 can retain credit information for user 102 and, responsive to instructions received from user 102 via PDD 202, can transmit a transaction request to retailer 216 via internet 214. As another example, a third party company can make the purchase on the behalf of user 102. For example, user 102 might authorize a cellular phone company knowing user 102's credit information to transmit the user's credit information to one of retailers 216(1-n) to effect a purchase. In any case, retailers 216(1-n) upon receipt of product information and credit information associated with user 102 are operative to obtain credit approval from credit company 222 and sell the product to user 102. Alternatively, the cellular phone company can pay for the purchase and charge for the purchase on user's 102 next bill.

The present invention provides several important advantages. First, user 102 can obtain product comparison information quickly wherever they have cellular service or wherever wireless Internet access is provided. Obtaining this information quickly saves user 102 airtime and battery life of their PDD 202, as opposed, for example, to using a web browser. Furthermore, user 102 is not burdened with the time necessary to comparison shop between various retailer websites. As still another advantage, user 102 is able to obtain specific information about the retailer, such as location and quantity on hand, to prevent unnecessary running around. Finally, user 102 is optionally able to directly purchase a product, via their PDD 202, such that they don't have to continue shopping in person for the product if so desired.

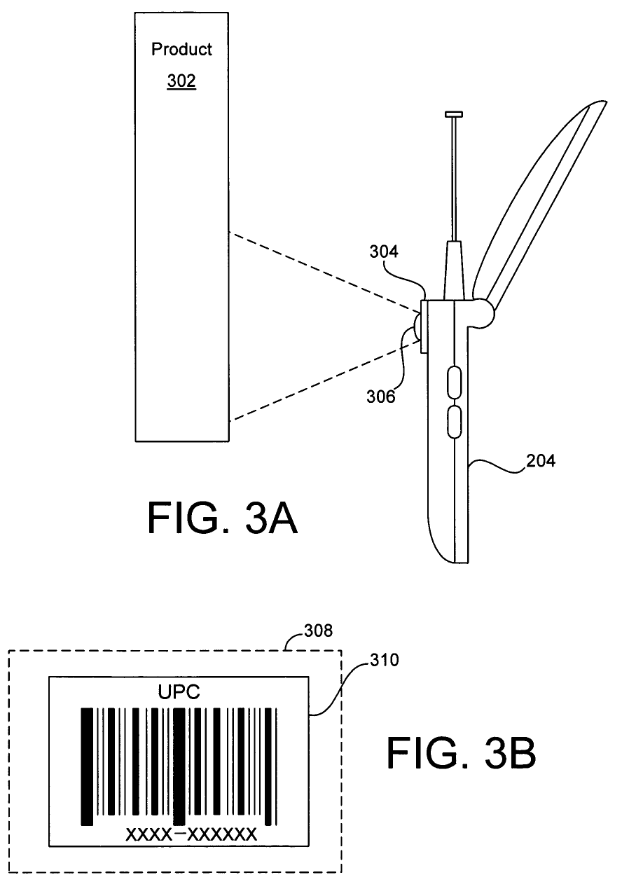

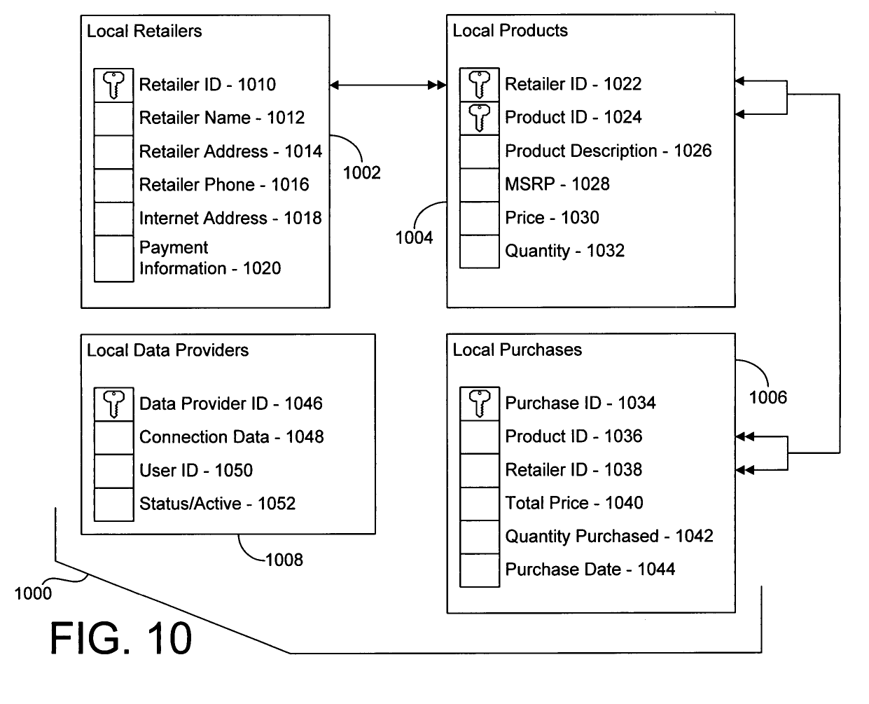

FIG. 3A shows a side view of camera phone 204 photographing a product identifier (not shown) on the packaging of a product 302. Camera phone 204 is shown to include a digital camera module 304 including a camera lens 306. Camera module 304 is capable of photographing product identifiers such as bar codes, and camera phone 204 includes software and/or firmware (FIG. 10) to discern a product identifier from the photograph.

FIG. 3B shows a digital photograph 308 taken of a product identifier 310 of product 302 by camera phone 204. In this particular example, the product identifier is a Universal Product Code (UPC) barcode. Camera phone 204 is capable of obtaining and decoding the UPC from the barcode in the photograph 308. Camera phone 204 is not limited solely to decoding UPC codes. In alternate embodiments, camera phone 204 could decode International Standard Book Numbering (ISBN) barcodes, barcodes identifying drugs, or any other graphically coded image currently in use or yet to be developed.

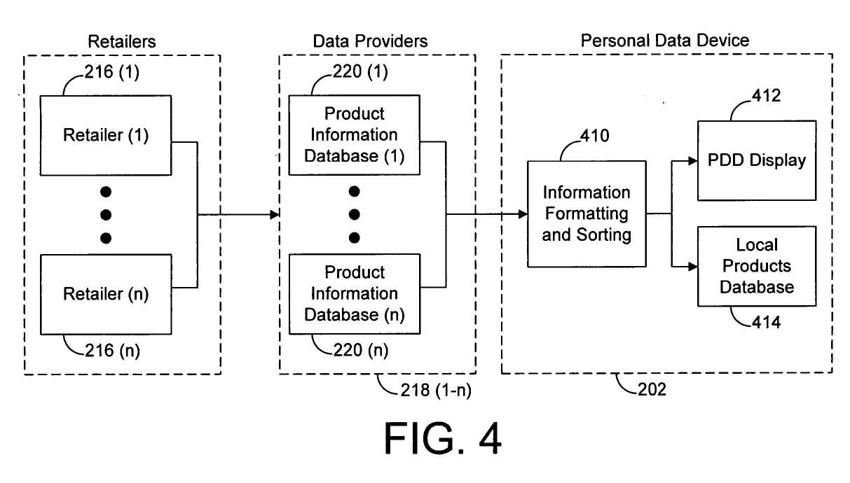

FIG. 4 shows the flow of product information from retailers 216(1-n) to a personal data device 202 according to one aspect of the present invention. Retailers 216(1-n) each sell one or more products. In order provide consumers with quick access to their product information, each of retailers 216(1-n) provides product information to one or more of data providers 218(1-n). The product information provided to data providers 218(1-n) is organized and stored in databases 220(1-n), and consists of retail procurement information including, but not limited to, product identifiers, product descriptions, prices, quantities on hand, and manufacturer's suggested retail prices (MSRP). Although not necessary, it is expected that each of retailers 216(1-n) will provide frequent product information updates to data providers 220(1-n) to keep data associated with their products up to date. For example, retailers 216(1-n) would want to notify the associated data provider(s) 218(1-n) if the price of a product changed. Updates could be accomplished according to a predetermined schedule and/or using data templates provided to the retailers 216(1-n) by the data providers 218(1-n).

Data providers 218(1-n) receive the product information from retailers 216(1-n) and assemble the information into product information databases 220(1-n), which are accessible to a user (e.g., user 102) of PDD 202. Information from retailers 216(1-n) is stored in records associated with product identifiers (e.g., a UPC code) such that the received product information can be quickly provided to personal data device 202 upon request therefrom. In addition to product information, each of data providers 218(1-n) also stores in databases 220(1-n) information about each of retailers 216(1-n) and about each user they service. Accordingly, because data providers 218(1-n) have retailer information stored in databases 220(1-n), they can easily and quickly provide retailer information to personal data device 202 in addition to product information. Also, because databases 220(1-n) include user information, data providers 218(1-n) can discriminate with respect to which users are allowed to access their service, such as would be the case if data providers 218(1-n) provided subscription access only.

The product information provided to PDD 202 from data providers 218(1-n) first undergoes information formatting and sorting 410, is then presented on a display 412 of PDD 202 such that it can be viewed by user 102, and/or is stored in a local products database 414 in the memory of PDD 202. Information formatting and sorting 410 includes formatting the information received from data providers 218(1-n) according to particular display and/or storage criteria defined by the user of PDD 202. For example, information formatting and sorting 410 might sort the products in the incoming product information by price, such that the products can be displayed by lowest to highest price. Alternately, information formatting and sorting 408 might parse and format the product information data into records which can be stored in local products database 414. Display 412, in this embodiment, is a conventional liquid crystal display (LCD) that displays pixilated images, but could be any type of display capable of displaying the product information provided by data providers 218(1-n). Local products database 414 stores product information received from data providers 218(1-n). This ensures quick retrieval of product information without having to unnecessarily transfer repeat data between data providers 218(1-n) and personal data device 408. Optionally, product information can be stored in local products database 414 from other sources (e.g., a data storage device, a home computer, directly from one or more of retailers 402(1-n), etc.). As another example, a query could be submitted and the returned data stored in local products database 414 prior to entering an area known to have no wireless access available.

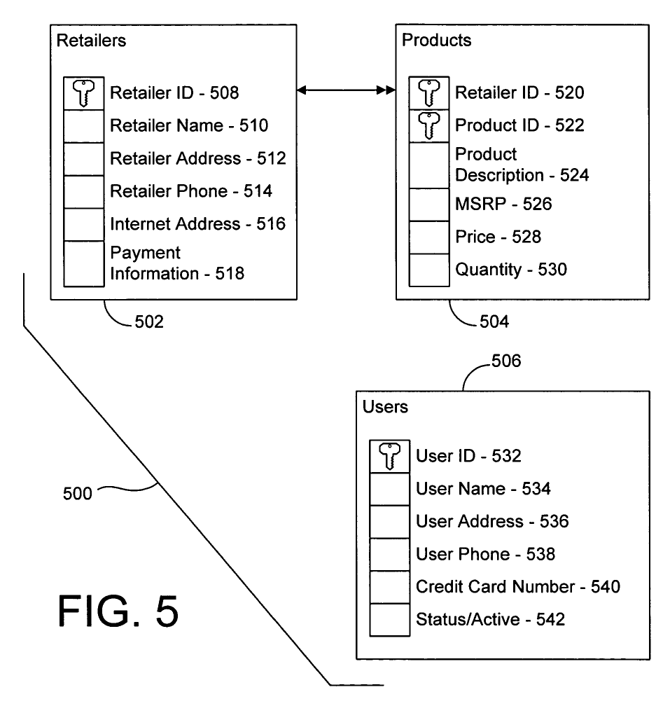

FIG. 5 shows an example data structure 500 to include a Retailers table 502, a Products table 504, and a Users table 506, for storing data in product information database 220 (FIG. 4). Retailers table 502 has a one-to-many relationship with Products table 504. That is, there can be many product records in Products table 504 associated with each of the retailer records of Retailers table 502. In the present embodiment, Users table 506 is a standalone table and is not related to other tables of the database, however it could be related to additional/alternate tables if so desired. Retailers table 502 stores records associated with the retailers 216(1-n), which provide information to the data provider 218. Products table 504 stores records of information associated with the products sold by associated retailers identified in table 502. Finally, Users table 506 stores records with information associated with users who are subscribed to the information services provided by data provider 218.

Each record in Retailers table 502 includes a “Retailer ID” field 508, a “Retailer Name” field 510, a “Retailer Address” field 512, a “Retailer Phone” field 514, an “Internet Address” field 516, and a “Payment Information” field 518. Retailer ID field 508 is the key field of Retailers table 502 and includes data representing a unique identifier for each retailer record stored therein. Retailer Name field stores data representing the name of the retailer associated with Retailer ID 508. Retailer Address field 512 stores data representing the associated retailer's address, and Retailer Phone field 514 stores data representing the associated retailer's phone number. Internet Address field 516 stores data indicative of the associated Retailer's Internet website address, if available. Finally, Payment Information field 518 stores data representing payment information for the specific retailer, for example, an electronic funds transfer (EFT) number, a merchant identifier to identify the retailer with credit company 222, a payment address, etc.

Each record in Products table 504 includes a “Retailer ID” field 520, a “Product ID” field 522, a “Product Description” field 524, an “MSRP” field 526, a “Price” field 528, and a “Quantity” field 530. Retailer ID field 520 and Product ID field 522 are key fields of Products table 504 and, in combination, include data representing a unique identifier for each record stored therein. Retailer ID field 520 includes the same data as Retailers ID field 508 of Retailers table 502, and associates each record of table 504 with a particular retailer record of Retailers table 502. Product ID field 522 is a product identifier and stores data indicative of a particular product, for example a UPC code. Product Description field 524 stores data describing the product associated with Product ID field 522. MSRP field 526 stores data indicative of the manufacturer's suggested retail price (MSRP) of the product associated with Product ID field 522. Price field 528 stores data indicative of the price the retailer associated with Retailer ID field 520 is asking for the particular product, and Quantity field 530 indicates the quantity of the particular product that the retailer associated with the product has on hand.

Each record in Users table 506 includes a “User ID” field 532, a “User Name” field 534, a “User Address” field 536, a “User Phone” field 538, a “Credit Card Number” field 540, and a “Status/Active” field 542. User ID field 532 is the key field of Users table 506 and includes data representing a unique identifier (e.g., a user name, cellular network subscriber number, etc.) for each user record stored therein. User Name field 534 stores data indicative of the user's name associated with a particular record. User Address field 536 stores data indicative of the user's address, and data indicative of the user's phone number is stored in User Phone field 538. Credit Card Number field 540 stores data representing the user's credit card number for purchases or subscription charges, and finally, the data in Status/Active field 542 indicates whether or not the user's account is active (e.g., via a single bit flag), such that the data provider 218 will know whether or not to provide product information to the user. Note that multibit data can be used to indicate a user's status with respect to various levels of service, for which data provider 218 can provide for free or for charges depending on the particular service level.

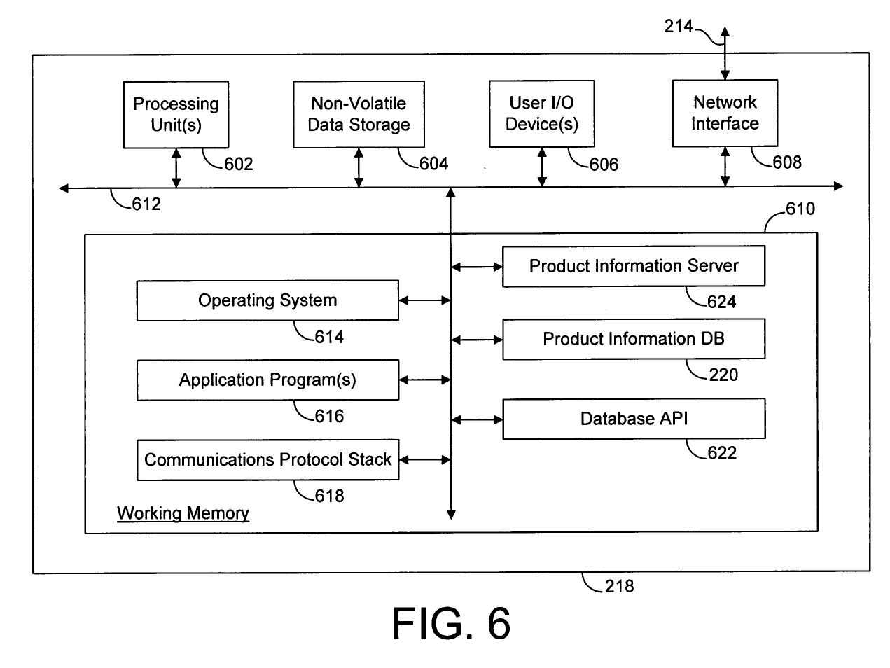

FIG. 6 is a block system diagram of one of data providers 218(1-n), which provides product information to personal data devices 202 according to one embodiment of the present invention. Data provider 218 includes one or more processing units 602, non-volatile data storage 604, one or more User Input/Output (I/O) devices 606, a network interface 608, and working memory 610, all interconnected via system bus 612 (e.g., PCI bus).

Processing unit(s) 602 execute(s) data and code stored in working memory 610, causing data provider 218 to carry out its various functions (e.g., receiving product information requests, providing product information reports, updating product information, etc.). Non-volatile memory 604 (e.g. read-only memory, or one or more hard disk drives, etc.) provides storage for data and code (e.g., boot code and programs) that are retained even when data provider 218 is powered down. I/O devices 606 facilitate interaction between a system administrator and data provider 218. I/O devices 606 would typically include a keyboard, mouse, monitor, printer, and other such devices that facilitate communications between data provider 218 and the administrator. Network interface 608 provides a connection between internet 214 and data provider 218. Typically, network interface 608 would communicate with an Internet Service Provider (ISP) over a broadband connection. Finally, system bus 612 facilitates intercommunication between the various components of data provider 218.

Working memory 610 (e.g. random access memory) provides temporary storage for data and executable code (e.g. an operating system 614), which is loaded into working memory 610 during system start-up and operation. Working memory 610 includes an operating system 614, one or more application programs 616, a communications protocol stack 618, product information database (DB) 220, a database Application Program Interface (API) 622, and a product information server 624. Generally, the foregoing modules will be loaded into and unloaded from working memory 610, as necessary, from alternate mass data storage devices including, but not limited to, a CD-ROM, a tape, a memory stick, a disk drive, or some other storage device having sufficient storage capacity such as one or more hard drives of nonvolatile data storage 604. For example, even though product information database 220 is shown in working memory 610, it is more likely that database 220 would be too large to reside in working memory 610. Therefore, the complete product information database 220 would likely be stored in nonvolatile data storage 604, with portions of database 220 being shuffled into and out of working memory 610 as necessary. Similarly, operating system 614, application program(s) 616, communications protocol stack 618, database API 622, and product information server 624 are shown as functional modules within working memory 610 for clarity of explanation.

The modules of working memory 610 provide the following functions. Operating system 614 provides a software platform on top of which the other programs can run. Application program(s) represent other miscellaneous applications (e.g., security applications, database maintenance applications, etc.) running in working memory 610. Product information server 624 services information requests/submissions from users 102 (FIG. 1) and retailers 216(1-n) (FIG. 2). Communications protocol stack 618 is a standard protocol stack (e.g., TCP/IP), which facilitates Product information server 624 communication with retailers 216(1-n) and user devices (e.g., PDD 202) over Internet 214. Product information database 220 stores data in the tables described in FIG. 5, such that retail information for various consumer products can be associated with different retailers 216(1-n). Database API 622 provides a protocol for information exchange between product information database 220 and Product information server 624. Optionally, retailers 216(1-n) and personal data devices 202 can use API 622 to exchange data directly with product information database 220.

Upon receiving a particular query via network interface 608 from a user 102, product information server 624 queries database 220 to determine whether there is a record in Users table 506 associated with the user 102, and if so whether data in status field 542 indicates that the user is active. If status/active field 542 associated with user 102 indicates that user 102 is active (e.g., a status flag is set high), then product information server will submit the query to database via API 622, receive the requested data from database 620 via API 622, and forward the requested data to user 102. If however, the status/active field 542 indicates that user 102 is inactive (e.g., a status flag is set low), or if no record associated with the user 102 is found, product information server 624 will discard the product information request and return an error message.

In order to respond to a product information request, product information server 624 queries data base 220, via API 622, for all relevant records associated with the product identifier(s) included in the product information request. In response to the query, database API 622 returns the relevant data to product information server 624 in a format defined by API 622. Product information server 624 then transmits the data, via internet 214, to PDD 202 (FIG. 2) for display to the user. Note that product information server 624 can transmit the data to PDD 202 in the same format received from database API 622 or, optionally, product information server 624 can sort, filter, or otherwise format the data in response, for example, to a parameter supplied by or associated with the particular user. For example, user 102 could provide a parameter with the data request causing product information server 624 to only return price information data. As another example, the product information request could include location data obtained from position detector 110, such that product information server 624 only returns product information associated with vendors within a predetermined proximity of PDD 202. As yet another example, sorting, filtering and/or formatting parameters associated with a particular user can be stored in Users table 506 and retrieved during the user verification (active/inactive) process described above. Finally, PDD 202 can, itself, sort, filter, and format data for presentation to the user, although filtering unwanted data at data provider 218 will shorten the time required to transmit the data to PDD 202.

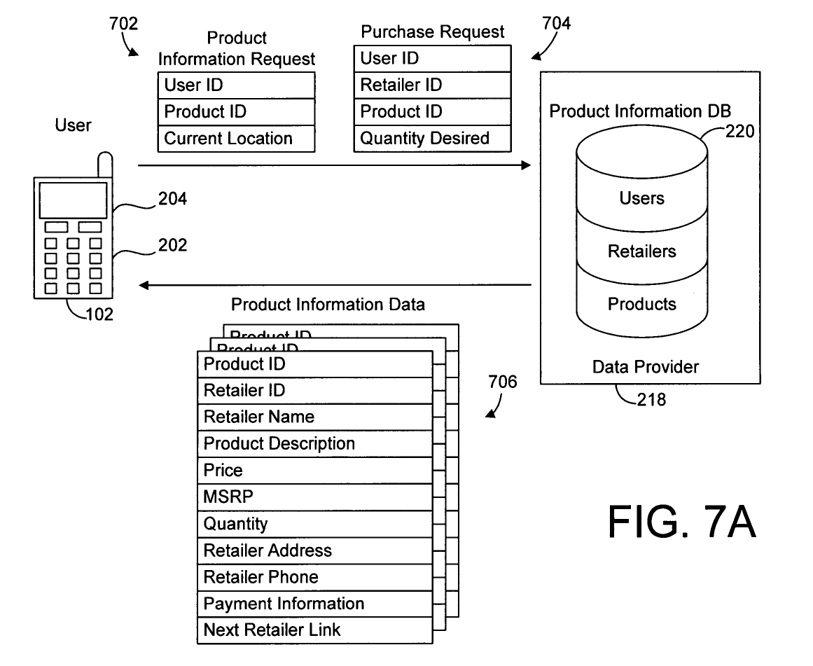

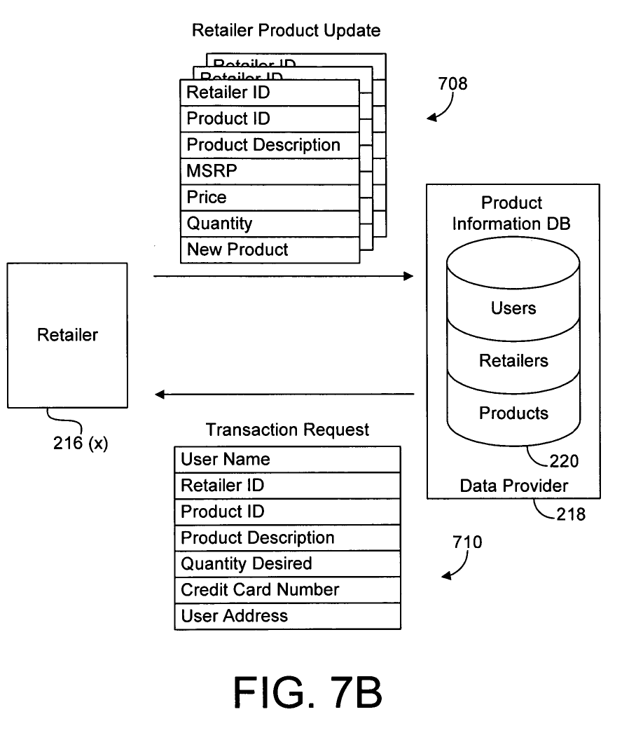

To update product information stored in product information database 220, retailers 216(1-n) submit product information updates (FIG. 7B) to product information server 624. product information server 624 then verifies the retailer by comparing a retailer identifier contained in the retailer information update query with Retailer ID field 508 of the records of Retailers table 502 (using API 622). If product information server 624 determines that the retailer information update does not match a retailer identified in Retailers table 502, the product information update is discarded. Alternately, if the product information update does correspond with a retailer in retailers table 502, then product information server updates the product record of table 504 associated with the product identifier and retailer identifier contained in the retailer information update, via API 622. If product information server 624 determines that the product information update contains a new product, a new product record is written to table 504 associating the new product and retailer. Optionally, new retailer records can be created in Retailers table 502 for unrecognized retailers.

PDD 202 can also transmit a purchase request to product information database 620 via database API 622. Upon receipt of the purchase request query, database 620 is operative to transmit a transaction request query with necessary user information (e.g., user name, address, etc.) and credit information to the associated retailer 216 via database API 622 and network interface 608. In the present embodiment, payment information field 518 of retailers table 502 provides database API an internet address for secure credit submissions to retailer 216 associated with the purchase. Storing the user's credit information in product information database 620 provides the benefit that the user's credit card number is not transmitted by personal data devices 202 to retailer 216 over unsecured connections.

It should be noted that the particular components of data provider 218 are provided to facilitate clear explanation and should not be construed as limiting the scope of the invention. For example, described modules that perform multiple functions (e.g., product information server 624) could be shown as a plurality of individual modules each responsible for a particular function. Indeed, additional modules may be added as necessary or modules presented herein may be modified and/or removed as appropriate for a particular application. Thus, the modules of data provider 218 described herein are not considered to be essential elements of the invention.

FIG. 7A is a block illustrating data transfer between personal data device 202 and data provider 218 (FIG. 2). In the present embodiment, user 102 is transmitting (via gateway 212 and internet 214) a product information request 702 and a purchase request 704 (separate transmissions) to product information database 220. In response to receiving product information request 702, product information data 706 is transmitted back to user 102.

Product information request 702 is a query generated by PDD 202, and includes a User ID field containing data indicative of the user, a Product ID field containing data indicative of a scanned product identifier, and a Current Location field containing data indicative of the current position of PDD 202 as determined by position detector 110. In response to receiving product information request 702, product information data 706 is sent from database 220 to PDD 202. Product information data 706 includes one or more records (three shown), each including a Product ID field, a Retailer ID field, a Retailer Name field, a Product Description field, a Price field, an MSRP field, a Quantity field, a retailer Address field, a Retailer Phone field, a Payment Information field, and a Next Retailer Link. Generally, the data contained in fields of product information data 706 corresponds to the data in the fields of the same name in product information database 220. The Next Retailer Link of each record contains a pointer to the next record. In the last record of the data, the field will include an “End of Data” indicator.

As discussed above, product information request 702 can include parameters (not shown) for causing data provider 218 (FIG. 2) to filter the data included in product information data 706. For example, product information request 702 might include instructions to product information server, such that product information data 706 only includes a Product ID, a Retailer Name, a Price, and a Quantity on hand, as opposed to all the data fields shown in product information data 706 in FIG. 7A. Alternately, data provider 218 could provide fewer data fields in the records as a default, and provide the additional data fields responsive to instructions included in product information request 702.

Purchase request 704 is a communication from PDD 202 that is transmitted to data provider 218, responsive to instructions from user 102. In response to receiving purchase request 704, data provider 218 assembles the required information and forwards a transaction request to the retailer 216 (FIG. 2) identified in the purchase request 704. Purchase request 704 includes a User ID corresponding to User ID field 532, a Retailer ID corresponding to Retailer ID field 508, a Product ID corresponding to Product ID field 522, and a Quantity Desired field including data indicative of the quantity of the product that user 102 desires to purchase.

FIG. 7B is a block diagram illustrating data transfer between an example retailer 216(x) and data provider 218. As shown, retailer 216(x) transmits (via internet 214) one or more (three shown) retailer product updates 708 to product information database 220 (via database API 622). Also shown is a transaction request 710 being transmitted from data provider 218 to retailer 216(x).

Retailer product updates 708 are used by data provider 218 to update the records in Products table 504 of database. Such updates are necessary to keep the records of Products table 504 current. Each retailer product update 708 includes a Retailer ID corresponding to Retailer ID fields 508 and 520, a Product ID corresponding to Product ID field 522, a Product Description corresponding to Product Description field 524, an MSRP corresponding to MSRP field 526, and a Quantity corresponding to Quantity field 530. Finally, each retailer product update 708 includes a New Product flag which is used to indicate to product information database 620 if the product identified by the Product ID is a first time submission for retailer 216(x). If so (e.g., the flag has a high value), product information database 620 creates a new record for the product in products table 504.

Transaction request 710 is generated by data provider 218 and is transmitted to retailer 216(x), responsive to the receipt of a purchase request 704 (FIG. 7A) from user 102. Transaction request 710 includes a User Name corresponding to User Name field 534, a Retailer ID corresponding to Retailer ID fields 508 and 520, a Product ID corresponding to Product ID field 522, a Product Description corresponding to Product Description field 524, a Quantity Desired corresponding to the Quantity Desired of purchase request 704, and a Credit Card Number corresponding to Credit Card Number field 540. After receiving transaction request 710, retailer 216(x) will submit the transaction to credit company 222 and, if approved, complete the transaction.

It should be noted that the communication data structures described in FIGS. 7A and 7B are considered to be a part of the present invention, but are provided by way of example. Indeed, the communications and data structures described herein can be modified for a particular application without departing from the scope of the invention. For example, some fields of transaction request 710 (e.g., the product description field) may not be required to complete a transaction. As another example, note that, as described, retailer product update 708 causes some existing records in database 220 to be updated. However, if the records of database include a time and/or date field, then database 220 can be updated simply by writing new records to database 220, without altering the existing records. In that case, queries of the database could simply filter out the older records.

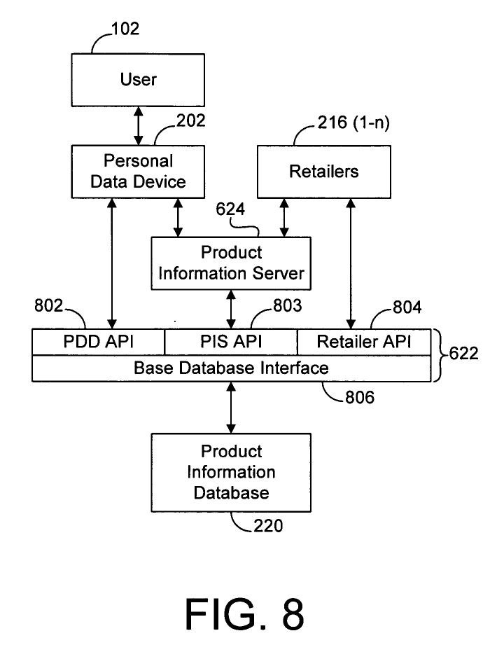

FIG. 8 is a block diagram showing database API 622 in greater detail. API 622 includes a PDD API 802, a product information server (PIS) API 803, and a retailer API 804, all interacting with product information database 220 via a base database interface 806. Base database interface 806 is a low level interface that reads records from and writes records to database 220. PDD API 802 defines the protocol for all queries and data write commands that can be submitted by PDD 202. Upon receiving a query from PDD 202, PDD API 802 retrieves records from database 220 via base database interface 806, processes the data according to the received query, and returns the processed data to PDD 202, all according to the format specified by PDD API 802 protocol. Upon receiving a write command and accompanying data from PDD 202, PDD API 802 arranges the data into records and writes the records to database 220 via base database interface 806.

PIS API 803 similarly defines the protocol for all queries and data write commands that can be submitted by product information server 624. Upon receiving a query from product information server 624, PIS API 803 retrieves records from database 220 via base database interface 806, processes the data according to the received query, and returns the processed data to product information server 624, all according to the format specified by PIS API 803 protocol. Upon receiving a write command and accompanying data from product information server 624, PIS API 803 arranges the data into records and writes the records to database 220 via base database interface 806.

Finally, retailer API 804 defines the protocol for all queries and data write commands that can be submitted by retailers 216(1-n). Upon receiving a query from a retailer 216, retailer API 804 retrieves records from database 220 via base database interface 806, processes the data according to the received query, and returns the processed data to retailer 216, all according to the format specified by retailer API 804 protocol. Upon receiving a write command and accompanying data from a retailer 216, retailer API 804 arranges the data into records and writes the records to database 220 via base database interface 806.

As described above and shown in FIG. 8, retailers 216 and PDD 202 can interact with database 220 either directly or through product information server 624. For example, as described above, responsive to instructions from user 102, PDD 202 can submit queries to product information server 624. Then, after verifying the status of user 102, product information server 624 retrieves the requested information, via API 622, from product information database 220 and forwards the requested data to PDD 202. However, once the status of user 102 is verified, it may be desirable to allow user 102 to submit queries via PDD 202 and PDD API 802 directly to product information database 220. Similarly, in some circumstances it may be desirable to require retailers 216 to access product information database 220 via product information server 624, whereas in other circumstances it may be desirable to allow retailers 216 to access database 220 directly via retailer API 804. API 622 provides such flexibility.

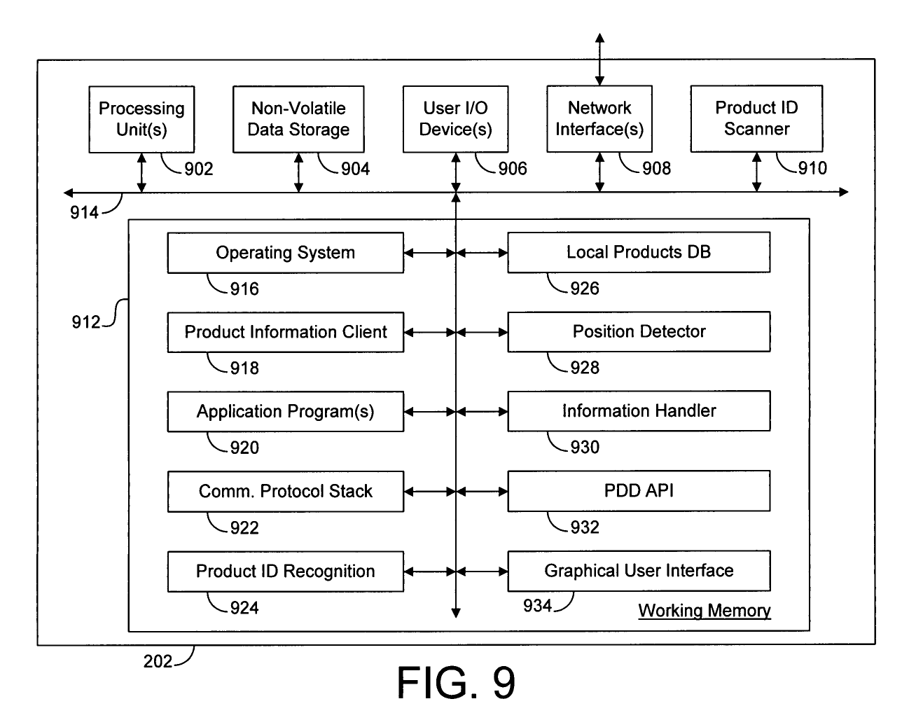

FIG. 9 is a block system diagram showing a PDD 202 for requesting product information from data providers 218(1-n) according to one embodiment of the present invention. PDD 202 includes one or more processing units 902, non-volatile data storage 904, one or more User Input/Output (I/O) devices 906, one or more network interface(s) 908, a product ID capture device 910, and working memory 1012, all interconnected via a system bus 914.

Processing unit(s) 902 imparts functionality to PDD 202 by processing data and executing code stored in working memory 912 for causing PDD 202 to carry out its various functions (e.g., generating product information requests, generating purchase requests, querying database 620, making cellular phone calls, etc.). Non-volatile memory 904 (e.g. read-only memory, flash memory, one or more hard disk drives, etc.) provides storage for data and code (e.g., boot code, an operating system, phone book, etc.) that are retained even when PDD 202 is powered down. I/O devices 906 facilitate interaction between user 102 and personal data device 202. I/O devices 906 typically include, by way of example, a display, keypad or keyboard, a pointing device, a speaker and microphone, and/or other such devices. Network interface(s) 908 provide(s) a connection between personal data device 202 and gateway 212 or some other. For example, network interface 908 could be an interface for communicating with a mobile telephone network. Alternately, network interface 908 could be a wireless interface for communicating wirelessly with an Internet Service Provider. As yet another example, network interface 908 could be an interface for a positioning system (e.g., a global positioning system, etc.) to receive position signals via an antenna (not shown). Finally, Product ID capture device 910 is, in this example embodiment, a scanner that facilitates scanning product identifiers such as product identifier 310. In a particular embodiment, product ID scanner 910 is a digital camera that can take a picture of the product identifier for decoding by PDD 202.

Working memory 912 (e.g. random access memory) provides working memory for processing unit(s) 902, and for illustrative purposes is shown to include executable code (e.g. an operating system 916) and data (e.g., local products database 926) modules. Working memory 916 includes an operating system 916, a product information client program 918, one or more application programs 920, a communications protocol stack 922, Product ID recognition code 924, a local products database (DB) 926, a position detector 928, an information handler 930, a PDD API 932, and a graphical user interface 933.

The modules of working memory 912 provide the following functions. Operating system 916 provides a software platform on top of which the other programs/modules can run. Product information client 918 is an application program that interacts with product information server 624 (FIG. 6) to effect the transfer of data therebetween and controls and coordinates the interaction of other modules of working memory 912 during operation. Application program(s) 1020 represent other applications (e.g., phone book applications, date books, database maintenance applications, etc.) that may be running in addition to or conjunction with the modules of the present invention. Communications protocol stack 922 is a standard protocol stack (e.g., TCP/IP) which facilitates communication between personal data device 202 and other electronic devices (e.g., data providers 218(1-n), etc.) over Internet 214. Product ID recognition 924 is a program for decoding or otherwise discerning a product identifier from data captured by product ID scanner 910. For example, in the case of a photograph of a barcode, product ID recognition 924 would be operative to discern the product identifier from the photograph of the barcode by using, for example, pattern recognition software. Local products database 926 includes a database of product information (e.g., a subset of product information database 624 (FIG. 6)) such that previously received data can be accessed even when PDD 202 cannot establish communication with one of data providers 218. Position detector 928, in the present embodiment, is a GPS module for detecting the position of PDD 202 via signal receiving circuitry (not shown). PDD API 932 provides a means for product information client to interact directly with both local products database 926 and product information database 220 of one of data providers 218(1-n). Information handler 930 sorts, filters, and/or formats the product information according to criteria selected by user 102 of PDD 202. Finally, graphical user interface 934 provides an interface for user 102 to interact with PDD 202, to facilitate functions such as formulating product information requests 702, formulating purchase requests 704 and viewing and manipulating the product information data 706 provided by data providers 218.

Local products database 926 stores information retrieved from databases 220 of data providers 218(1-n). Storing the retrieved information provides several advantages. First, having access to retailer and product information on personal data device 202 saves communications charges which may be incurred when PDD 202 repeatedly requests product information from data providers 218(1-n) for the same product. As another example, it is anticipated that the information stored in local products database could be retrieved before user 102 even goes shopping. This would be especially beneficial if one was shopping in an unfamiliar area, or in an area without cellular or wireless internet service. Although local products database must compete with other components (e.g., cell phone address book, camera phone software, digital photographs, etc.) for valuable memory resources, it is anticipated that the benefits provided warrant allocating at least some memory for local product database 926. Further, as storage capacity in mobile devices increases, it is expected that local products database 926 will become increasingly useful.

FIG. 10 shows an example data structure 1000 useful for storing data in local products database 926. Data structure 1000 includes a Local Retailers table 1002, a Local Products table 1004, a Local Purchases table 1006, and a Local Data Providers table 1008, each of which is stored in a local products database 926 of PDD 202. Note that the descriptor “Local” indicates that the respective tables are stored on PDD 202. Local Retailers table 1002 stores information associated with retailers 216(1-n). Local Products table 1004 stores information associated with the products sold by corresponding retailers identified in table 1002. Local Purchases table 1006 stores records associated with purchases that have been previously made via PDD 202. Finally, Local Data Providers table 1008 stores records associated with data providers 218(1-n) that user 102 is subscribed to. Each record in Local Retailers table 1002 has a one-to-many relationship with the records of Local Products table 1004, because each retailer will likely offer more than one product. In addition, each record in Local Products table 1004 has a one-to-many relationship with the records in Local Purchases table 1006, because user 102 may purchase the same product from the same retailer more than once.

Each record in Local Retailers table 1002 includes a “Retailer ID” field 1010, a “Retailer Name” field 1012, a “Retailer Address” field 1014, a “Retailer Phone” field 1016, an “Internet Address” field 1018, and a “Payment Information” field 1020. Retailer ID field 1010 is the key field of Retailers table 1002 and includes data representing a unique identifier for each retailer record stored therein. Retailer Name field 1012 stores data representing the name of the retailer associated with Retailer ID 1010. Retailer Address field 1014 stores data representing the retailer's address, and Retailer Phone field 1016 stores data representing the retailer's phone number. Internet Address field 1018 stores data indicative of the Retailer's Internet address, if available. Finally, Payment Information field 1020 stores data representing payment information for the specific retailer 216, for example, an electronic funds transfer (EFT) number, a merchant identifier to identify the retailer 216 with credit card companies, a payment address, etc.

Each record in Local Products table 1004 includes a “Retailer ID” field 1022, a “Product ID” field 1024, a “Product Description” field 1026, an “MSRP” field 1028, a “Price” field 1030, and a “Quantity” field 1032. Retailer ID field 1022 and Product ID field 1024 are the key fields of Local Products table 1004 and, in combination, include data representing a unique identifier for each record stored therein. Retailer ID field 1022 includes the same data as Retailers ID field 1010 of Retailers table 1002, and relates each record of table 1004 with a particular retailer record of Retailers table 1002. Product ID field 1024 stores data identifying of a particular product, for example a UPC code. Product Description 1026 stores data describing the product associated with Product ID field 1024. MSRP field 1028 stores data indicative of the manufacturer's suggested retail price of the product associated with Product ID field 1024. Price field 1030 stores data indicative of the price the retailer associated with Retailer ID field 1022 is asking for the particular product, and Quantity field 1032 indicates the quantity of the particular product that the retailer associated with the product has on hand. Optionally, Quantity field 1032 may simply contain a binary indicator that indicates whether the associated retailer has any of the product on hand or not.

Each record in Local Purchases table 1006 includes a “Purchase ID” field 1034, a “Product ID” field 1036, a “Retailer ID” field 1038, a “Total Price” field 1040, a “Quantity Purchased” field 1042, and a “Purchase Date” field 1044. Purchase ID field 1034 is the key field of Local Purchases table 906 and stores a unique identifier corresponding to each purchase that user 102 has made via personal data device 202 for each record. The unique identifier is generated when the record is stored. Product ID field 1036 and Retailer ID field 1038 each contain data indicative of a particular retailer and product associated with the purchase, and combined, relate the purchase to a record of local products table 1004. Total Price field 1040 includes data indicative of the total purchase price paid (e.g., base price× quantity+ sales tax), and Quantity Purchased field 1042 indicates the total quantity of the product associated with Product ID field 1036 that was purchased. Finally, Purchase Date field 1044 includes data indicative of the purchase data (and optionally time) that the transaction was made.

Each record in Local Data Providers table 1008 includes a “Data Provider ID” field 1046, a “Connection Data” field 1048, a “User ID” field 1050, and a “Status/Active” field 1052. Data Provider ID field 1046 is the key field of Local Providers table 1008 and includes data representing a unique identifier for each Data Provider record stored therein. Connection data field 1048 includes data indicative of a connection address or indicator (e.g., a network address, dial-up number, etc.) for PDD 202 to connect with the data provider 218 associated with Data Provider ID field 1046. User ID field 1050 stores data indicative of a user identifier required to obtain access to the information stored in the database 220 of the associated data provider 218. Finally, Status/Active field 1052 includes data (e.g., a flag) indicating whether user 102 of personal data device 202 has access to the data provided by a particular data provider. For example, Status/Active field 1050 might indicate if user 102 has a subscription to the data service provided by a particular data provider. Alternately, Status/Active field 1052 might include subscription date data indicating between what dates user 102 would have access to the information provided by the data provider.

The operation of the example embodiment of the invention will now be described with reference to FIG. 9 and FIG. 10. Product information client 918 generates a product information request responsive to instructions received from user 102 via one of User I/O devices 906. The instructions received from user 102 include, for example, the selection of a data provider identifier and a product identifier. Product information client 918 then querys local database 926 for records associated with the product identifier. If local products database 1026 contained no records associated with the identified product, or if user 102 wanted additional and/or updated information related to the product, then product information client 918 would query the data provider 218(1-n) for such additional information. As described above, depending on the particular application, product information client 918 can retrieve the information by transmitting a product information request to product information server 624 (FIG. 6), or by directly querying product information database 220 via PDD API 932.

In order to transmit the product information request to data provider 218, product information client 918 querys local database 926 for a record in Local Data Providers table 1008 associated with the data provider identifier selected by user 102 by matching the data stored in Data Provider ID field 946 with the selected identifier. If Status/Active field 1052 indicates that the subscription with the associated data provider 218 is active, product information client 918 reads the connection data 1048 and User ID 1050 from the data provider record of table 1008. Next, product information client 918 retrieves location data from position detector 928, and transmits a product information request 702 to data provider 218 via network interface 908 using the connection data 1048. Product information client 918 then waits to receive the requested product information data 706 from data provider 218, via network interface 908.

Upon receiving the requested information, product information client 918 calls information handler 930 to sort, filter, and/or format the received product data for presentation to user 102 via GUI 934 and user I/O devices 906. Responsive to instructions from user 102, information handler 930 processes the product information data 706 received by PDD 202. For example, information handler 930 can arrange the product information data 706 by price, by proximity of retailer, by price and proximity, by quantity on hand, by purchase ability via PDD 202, or by any other useful criteria. In the case of sorting by retailer proximity, information handler 930 calls position detector 928 to determine the current location of PDD 202.

Note that if local products database 926 had contained information associated with the identified product, then product information client 918 could have retrieved the product information data from local products database 926 instead of data provider 218. Optionally, product information client 918 can retrieve data from both local products database 926 and one or more data providers 218. Indeed, in one embodiment, product information client 918 retrieves data from any combination of the available data sources, local or remote, depending on predefined user settings (not shown).

PDD 202 can be used to make a purchase as follows. Responsive to instructions from user 102 including selection of a retailer identifier and a product identifier, product information client 918 is operative to transmit a purchase request (e.g., purchase request 704, FIG. 7A) to product information server 624 of data provider 218. Then, data provider 218 makes the purchase of the identified product from the identified retailer on behalf of user 102. Alternatively, product information client 918 can submit a transaction request 710 (FIG. 7B) directly to one of retailers 216(1-n) via internet 214 by obtaining their payment information 1020 from table 1002 and the user's payment information from user 102 (e.g., previously stored in PDD 202). Optionally, retailer 216 and/or product information server 624 provides a confirmation of the transaction to PDD 202.

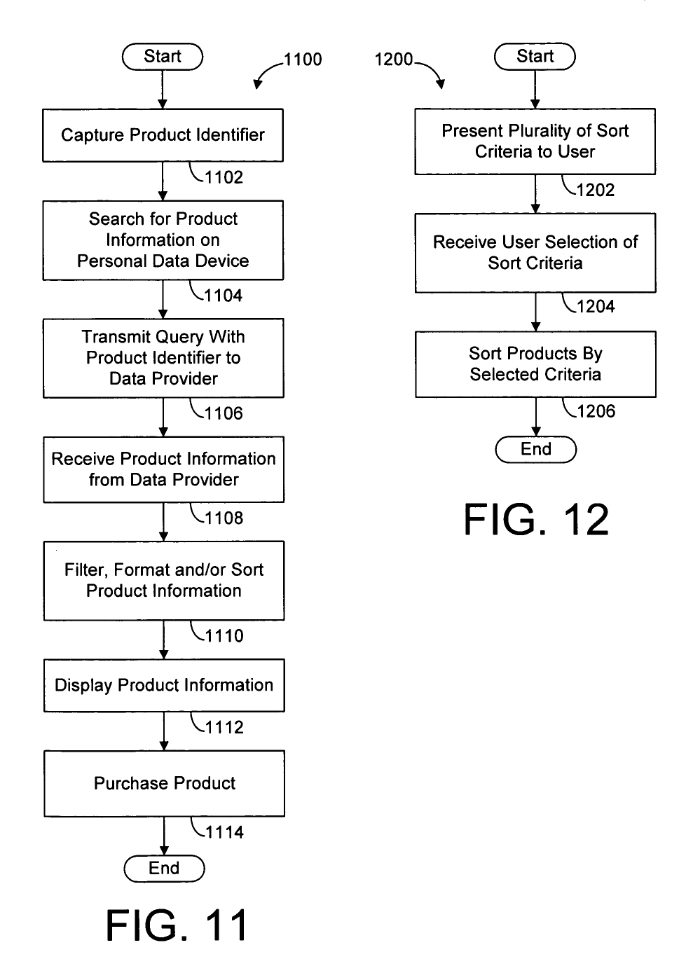

FIG. 11 is a flowchart 1100 summarizing one method of using product identifiers to obtain product information according to one embodiment of the present invention. In a first step 1102, user 102 captures a product identifier using product ID scanner 910 of personal data device 202. Then in a second step 1104, user 102 searches for product information corresponding to the scanned product by querying local products database 1026 stored in PDD 202. Then, in a third step 1106, user 102 instructs PDD 202 to query database 220 of one of data providers 218(1-n) with a product information request 702 including the captured product identifier. Next, in a fourth step 1108, PDD 202 receives product information data 710 from the queried data provider 218. In a fifth step 1110, information handler 930 of PDD 202 filters, formats, and/or sorts the received data according to user specified criteria (e.g., price, proximity, etc.). Then, in a sixth step 1112, the processed product information is displayed to user 102 on PDD 202. Finally, in a seventh step 1114, responsive to instructions from user 102, product information client 918 generate and transmit a purchase request 704 to data provider 218 or retailer 216.

FIG. 12 is a flowchart summarizing one method 1200 of performing fifth step 1110 (Filter, Format and/or Sort Product Information) of FIG. 11. In a first step 1202, product information client 918 presents a plurality of sort criteria to user 102, via GUI 934 and user I/O devices 906. Next, product information client 918 receives an indication of the user's selection of one or more of the presented sort criteria, via GUI 934 and user I/O devices 906. Finally, in a third step 1206, information handler 930 sorts the product information according to the selected criteria.

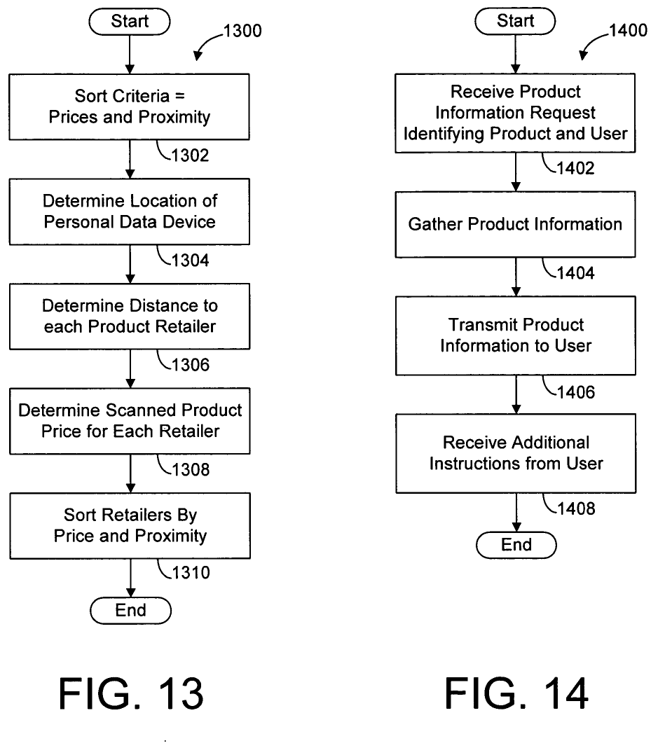

FIG. 13 is a flowchart summarizing another method of performing fifth step 1110 of FIG. 11. In a first step 1302, information handler 930 determines that the product information data 710 is to be sorted by price and retailer proximity. Then, in a second step 1304 information handler 930 obtains the current location of personal data device 202 by requesting the current location from position detector 918. Next, in a third step 1306, information handler 930 calculates the distance from PDD 202 to each retailer 216 selling the requested product for each record. Then in a fourth step 1308, information handler 930 determines the price of the requested product offered by each retailer 216. Finally, in a fifth step 1310, information handler sorts the records by price and proximity.

FIG. 14 is a flowchart summarizing one method 1400 for data providers 218(1-n) to use product identifiers to supply product information to PDD 202. In a first step 1402, a particular data provider 218 receives a product information request (e.g., product information request 702) including a product identifier for identifying the product and a user identifier for identifying the user 102. Then, in a second step 1404, product information server 624 gathers the requested information by querying product information database 220 for records associated with the received product identifier. Next, in a second step 1406, product information server 624 transmits the product information data 710 back to PDD 202 via internetwork 114. Finally, in a fourth step 1408, data provider 218 receives additional instructions (e.g., purchase requests, user information update, etc.) from user 102 via network interface 608.

The above described embodiments of the present invention concentrated on using a captured product identifier to supply retail information to PDD 202. It should be noted, however, that the present invention is not limited to the provision of retail information. Indeed, data providers 218 are designed such that they can provide many different kinds and combinations of information to a user upon receipt of a query including a product identifier. Some additional examples, which are considered to be inventive aspects of the present invention, are described below.

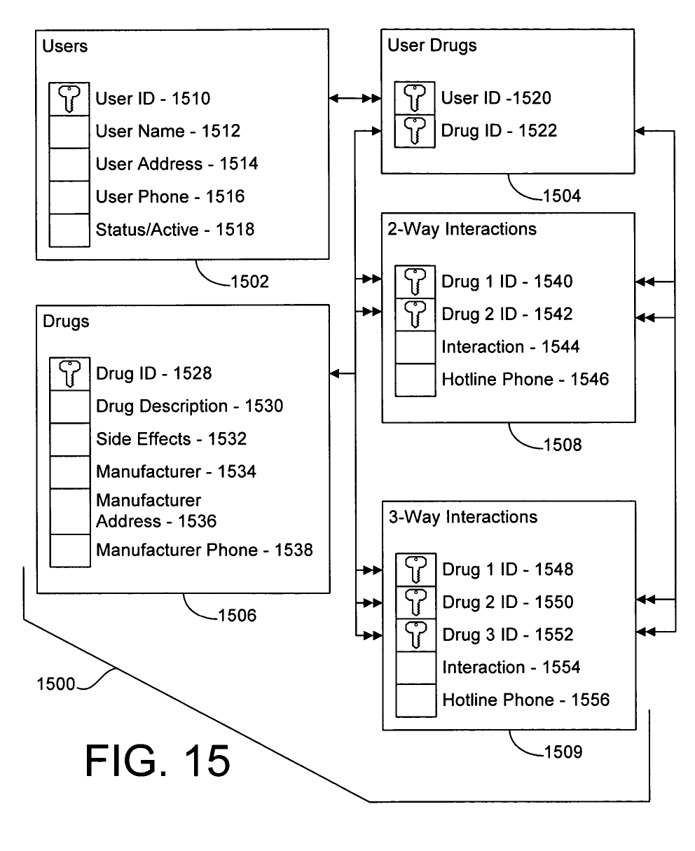

FIG. 15 shows an example data structure 1500 for storing information in product information database 624, which can be used to provide information on drug interactions responsive to a query with a product identifier indicative of a particular drug. The inventors suppose that drug interaction databases exist, such as may be used by a pharmacy when dispensing prescription medications. However, as will be described in greater detail below, this aspect of the invention is directed to a system and method whereby a consumer can capture a product identifier associated with a drug (e.g., a prescription or an over-the-counter drug) and retrieve drug interaction information associated with the drug.

Data structure 1500 includes a Users table 1502, a User Drugs table 1504, a Drugs table 1506, a Two-Way Interactions table 1508, and a Three-Way Interactions table 1509, all of which are stored in database 620 of a data providers 218. Users table 1502 stores general information related to particular subscribers of the service provided by drug interaction data provider 218. User Drugs table 1504 stores drug identifiers associated drugs taken by each user of Users table 1502. Drugs table 1506 stores general drug information for a variety of different drugs on the market. Two-Way Interactions table 1508 stores records of any adverse drug interactions involving any two drugs of Drugs table 1506. Finally, Three-Way Interactions table 1509 stores records of any adverse drug interactions involving any combination of three drugs of Drugs table 1506.

Each record in Users table 1502 includes a “User ID” field 1510, a “User Name” field 1512, a “User Address” field 1514, a “User Phone” field 1516, and a “Status/Active” field 1518. User ID field 1510 is the key field of Users table 1502 and includes data representing a unique identifier assigned to each user record stored therein. User Name field 1512 stores data indicative of the user's name associated with a particular record. User Address field 1514 stores data indicative of the user's address, and User Phone field 1516 stores data indicative of the user's phone number. Finally, Status/Active field 1518 contains data indicative of whether or not an associated user's subscription is active.

Each record in User Drugs table.1504 includes a “User ID” field 1520 and a “Drug ID” field 1522. User ID field 1520 and Drug ID field 1522 are, in combination, the key fields of table 1504 and, in combination, form a unique identifier for each record of table 1504. User ID field 1520 stores the same data as User ID field 1510 of Users table 1502, and associates each User Drugs record with a particular Users record. Drug ID field 1522 contains an identifier indicative of a pre-identified drug the user associated with User ID field 1520 is currently taking. User Drugs table 1504 will contain a particular record for each pre-identified medication that a particular user is taking.

Each record in Drugs table 1506 includes a “Drug ID” field 1528, a “Drug Description” field 1530, a “Side Effects” field 1532, a “Manufacturer” field 1534, a “Manufacturer Address” field 1536, and a “Manufacturer Phone” field 1538. Drug ID field 1528 is the key field of Drugs table 1506, and represents a unique identifier for each drug record contained therein. Drug Description field 1530 stores data representing a brief description (e.g., name, purpose, use directions, etc.) of the drug identified by Drug ID field 1528. Side Effects field 1532 stores data indicative of the side effects and/or adverse reactions associated with each particular drug, including dosages necessary to induce the reaction. Finally, Manufacturer field 1534, Manufacture Address field 1536, and Manufacture Phone field 1538 each store information indicative of the manufacture, the manufacturer's address, and the manufacture's phone number, respectively, associated with each drug record.

Each record in Two-Way Interactions table 1508 includes a “Drug 1 ID” field 1540, a “Drug 2 ID” field 1542, an “Interaction” field 1544, and a “Hotline Phone” field 1546. Drug 1 ID field 1540 and Drug 2 ID field 1542 are, in combination, the key fields of Two-Way Interactions table 1508 and, in combination, form a unique identifier for each 2-way interaction record contained therein. Drug 1 ID field 1540 and Drug 2 ID field 1542 each contain a drug identifier indicative of a particular drug, the combination of which may cause a drug interaction associated with a particular record of table 1508. Interaction field 1544 includes data describing the interaction between the drugs identified in Drug ID fields 1540 and 1542. Hotline Phone field 1546 contains data indicative of the phone number of an emergency hotline in case the particular interaction described in Interaction field 1544 occurs and/or to get additional information regarding the potential interaction.

Each record in Three-Way Interactions table 1509 includes a “Drug 1 ID” field 1548, a “Drug 2 ID” field 1550, a “Drug 3 ID” field 1552, an “Interaction” field 1554, and a “Hotline Phone” field 1556. Drug 1 ID field 1548, Drug 2 ID field 1550, and Drug 3 ID field 1552 are, in combination, the key fields of Three-Way Interactions table 1509 and, in combination, form a unique identifier for each 3-way interaction record contained therein. Drug 1 ID field 1548, Drug 2 ID field 1550, and Drug 3 ID field 1552 each store a drug identifier indicative of a particular drug, the combination of which may cause a drug interaction associated with a particular record of table 1509. Interaction field 1554 includes data describing the interaction between the drugs identified in Drug ID fields 1548, 1550 and 1552. Hotline Phone field 1556 contains data indicative of the phone number of an emergency hotline in case the particular interaction described in Interaction field 1554 occurs and/or to get additional information regarding the potential interaction.

The tables of FIG. 15 have the following inter-relationships. Each record of Users table 1502 has a one-to-many relationship with the records of User Drugs table 1504, such that each user may pre-identify multiple drugs that he/she is currently taking, if so desired. The records of Drugs table 1506 each have a one-to-many relationship with the records of User Drugs table 1504, the records of Two-Way Interactions table 1508, and Three-Way Interactions table 1509. Finally, the records of User Drugs table 1504 have a one-to-many relationship with the records of Two-Way Interactions table 1508 and Three-Way Interactions table 1509, because every drug identified in a User Drugs record may relate to more than one interaction record of Two-Way Interactions table 1508 and Three-Way Interactions table.

It should be noted that the database tables described in FIG. 15, or some subset thereof, could also be stored in local products database 1026 of personal data device 202 such that user 102 would have the drug interaction information contained therein readily accessible, as described above with reference to the retail product information aspect of the invention.

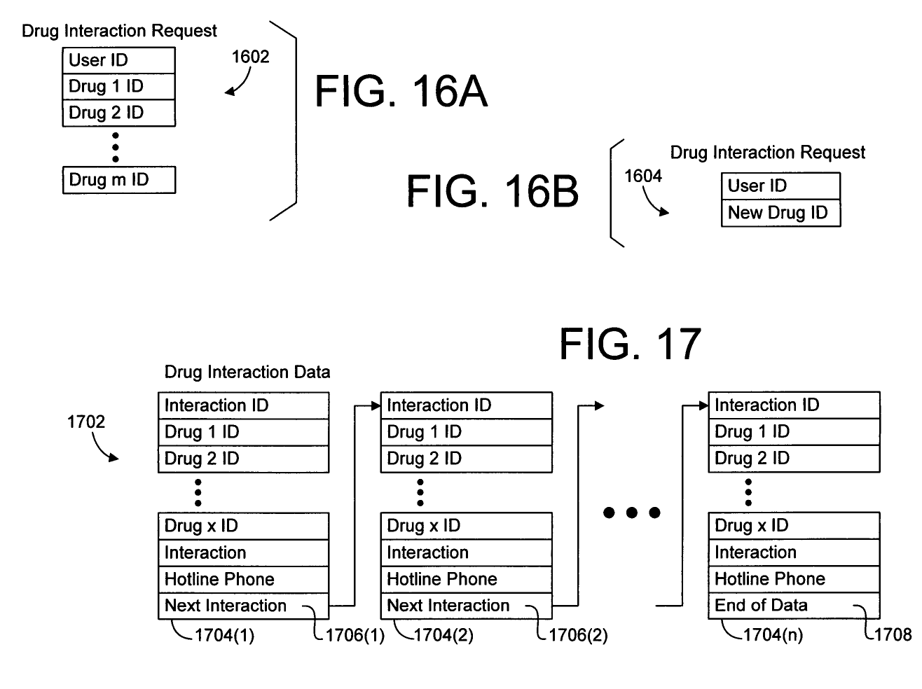

FIG. 16A shows an example of a Drug Interaction Request 1602 sent by user 102 to a data provider 218 hosting a database 220 including the tables of FIG. 15. Drug interaction request 1602, like product information request 702, is a query that causes data provider 218 to retrieve relevant product information, in this case drug interaction information, from data base 220 and transmit the drug interaction information back to PDD202. Drug interaction request 1602 includes data representing a User ID of user 102 and a plurality of drug identifiers, shown as Drug 1 ID, Drug 2 ID up to Drug m ID. Drug interaction request 1602 would typically be used when user 102 is first transmitting their drug information to drug interaction data provider 218, or is considering starting a regiment of two or more new drugs. In any case, product information server 624 searches database 220 for any interactions associated with any combination of the drugs identified in drug interaction request 1602 and any other drugs previously associated with the user by records stored in User Drugs table 1504, if any exist. Then, product information server 624 transmits the retrieved data to PDD 202.

The data structure of drug interaction request 1602 can also be used as an instruction to write corresponding records to User Drugs table 1504. For example, a simple parameter (not shown) could be included with drug interaction request 1602 to indicate whether new records are to be stored in User Drugs table 1504, interaction data is to be returned, or both. In one embodiment, the parameter is simply the command/query name transmitted with drug interaction request 1602.

FIG. 16B shows an alternate Drug Interaction Request 1604 sent by user 102 to drug interaction data provider 218. Drug interaction request 1604 is a query and includes data representing the User ID of user 102 and a single drug identifier. Drug interaction request 1604 would commonly be submitted to data provider 218 by user 102 after user 102 has at least one established User Drugs record in table 1504. Accordingly, data provider 218 would provide user 102 with any interactions between combinations of the new drug contained in drug interaction request 1604 and the drugs identified in the associated User Drugs records of table 1504. Similar to drug interaction request 1602, as indicated above, drug interaction request 1604 can include a parameter to indicate to data provider 218 to store a record associating the user and the drug identifier in User Drugs table 1504.

FIG. 17 shows one example of a data structure for transmitting Drug Interaction Data 1702 from data provider 218 to user 102. Drug Interaction Data 1702 includes a plurality of drug interaction records 1704(1-n). Drug interaction records 1704(1-n) contain substantially the same information as an associated interaction record of Two-Way Interactions table 1508 or Three Way Interactions table 1509. In addition, drug interaction records 1704(1-(n−1)) include a pointer 1706(1-(n−1)) to the next drug interaction record. Drug interaction record 1704(n) includes an “End of Data” flag 1708, which indicates that there are no more records in drug interaction data 1702.

It should be noted that the drug identifiers (1-x) contained in drug interaction data 1702 are intended to represent different numbers of drugs involved in a particular reaction. Although the tables of FIG. 15 only show reactions for interactions caused by two or three drugs, it is anticipated that additional tables would be created for interactions caused by 3, 4, and 5 or more drugs. Therefore, report 1702 shows x amount of drug identifiers to account this capability.

It should also be noted that the queries and returned data described in FIGS. 16A, 16B and 17 are exemplary in nature. Indeed, the record fields, queries, and returned data described herein can be modified or new ones can be added as needed. Those skilled in the art of database programming will understand that certain basic features have been omitted from this description so as not to unnecessarily obscure the main aspects of the present invention. For example, commands will be provided in an API between PDD 202 and product information server 624 to allow a user 102 to add and/or remove records associated with the particular user from User Drugs table 1504.

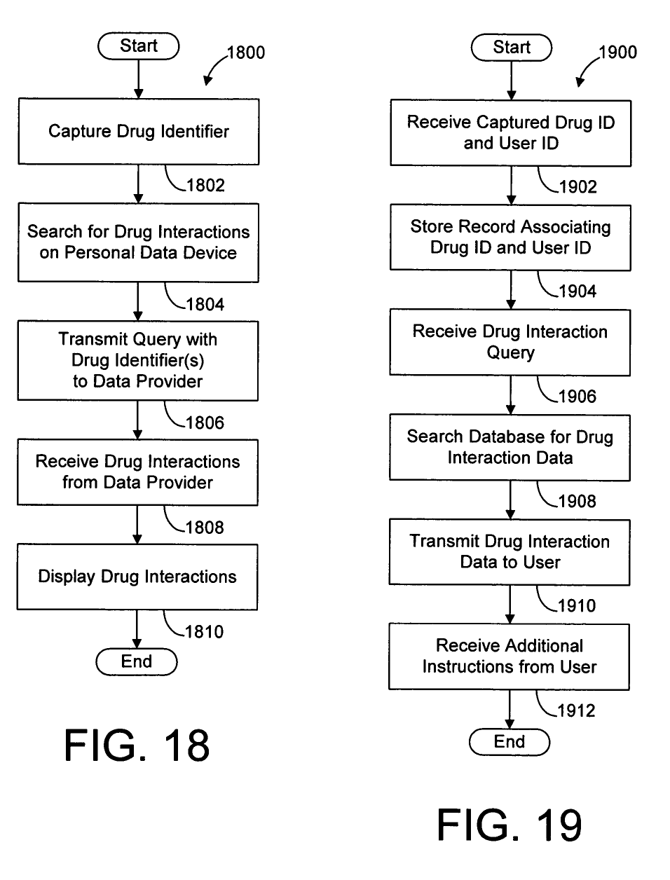

FIG. 18 is a flowchart summarizing one method 1800 for user 102 to retrieve drug interaction information according to the present invention. Method 1800, as well as the other methods disclosed herein, are described for illustrative purposed with reference to the components and modules of FIGS. 2, 6 and 9. However, it should be understood that the described methods are not limited to the use of any particular hardware or software implementations.

In a first step 1802, user 102 captures a drug identifier (e.g., a UPC barcode or a pharmaceutical barcode on a drug container) with product ID scanner 910. Optionally, user 102 can capture multiple drug identifiers. Then, in second step 1804, product information client 918 searches local products database 926 (which includes the tables of FIG. 15) for relevant drug interaction records. Then, in a third step 1806, responsive to instructions from user 102, PDD 202 transmits a drug interaction request 1602 or 1604, via internet 214, to product information server 624 of data provider 218. Next, in a fourth step 1808, product information client 918 of PDD 202 receives drug interaction data 1702 from product information server 624. Finally, in a fifth step 1810, PDD 202 displays the drug interaction data 1702 to user 102.

FIG. 19 is a flowchart summarizing one method 1900 for providing drug interaction information to user 102 according to the present invention. In a first step 1902 product information server 624 of data provider 218 receives a drug interaction request query 1602 or 1604 including a captured drug identifier and a user identifier from product information client 918. Then, in a second step 1904, product information server 624 writes a record to product information database 220 associating the captured drug identifier and the user identifier. Next, in a third step 1906, product information server 624 receives a drug interaction request 1602 or 1604, including at least one captured drug identifier and a user identifier, from product information client 918. Then, in a fourth step 1908, product information server 624 searches database 220, via database API 622, to locate all drugs previously associated (e.g., by records in table 1504) associated with the identified user and for all drug interaction records associated with any combination of the previously associated drugs and the drug(s) identified in the drug interaction request 1602 or 1604. In particular, product information server 624 searches the records of Two-Way and Three-Way Interactions tables 1508 and 1509 for any combination of drugs contained in drug interaction request 1602 or 1604 and the drugs contained in the user's User Drug records in table 1504. Next, in a fifth step 1910, product information server 624 transmits any returned drug interaction data 1702 to product information client 918. Finally, in a sixth step 1912, product information server 624 receives any additional instructions from product information client 918 of PDD 202, for example, a connection termination, another drug interaction request, information update commands, etc.

Note that method 1900 can be performed without first step 1902 and second step 1904. In particular, in third step 1906, product information server 624 could receive a single drug interaction query including a plurality of captured drug identifiers. Then, even if there were no previously stored records associating user 102 with other drugs, product information server 624 can still search database 220 for interactions between the plurality of drugs identified in the received drug interaction query. Then, method 1900 proceeds as described above.

It should be noted that the drug information used in conjunction with the present invention can be associated with both prescription or over-the-counter drugs. The present embodiment of the invention allows user 102 to determine if a new drug will interact with any drugs he/she is already taking. This would be especially useful in a supermarket to determine if an over-the-counter drug would interact with any prescription drugs user 102 is already taking. As another option, drug interaction data provider 218 could also provide information about bad and/or recalled lots of specific drugs. As yet another example, drug interaction data provider 218 could also provide notification regarding a drug's contra-indicated medical conditions. For example, a person with liver damage might not want to take a drug that is metabolized in the liver. In such embodiments of the invention, product information database will include tables wherein users can store records associating their particular medical conditions with their user identifier. It should also be noted that, although not described in detail, it is expected that drug interaction data provider 218 will receive drug interaction updates from drug manufacturers to update drug interaction information and to provide new drug information.

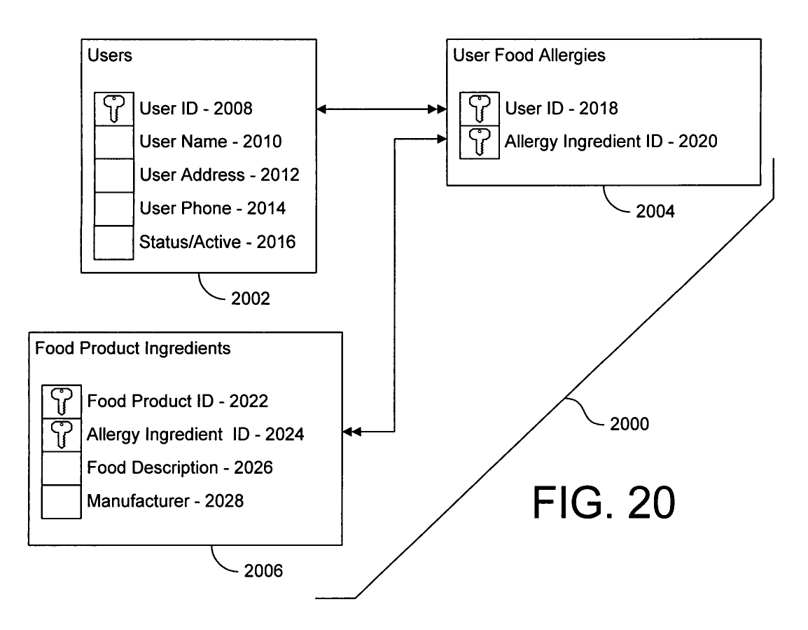

FIG. 20 shows an example data structure 2000 useful for storing data associated with users' food allergies in database 220 of data provider(s) 218. Using this data, product information server 624 can alert a user if a particular food product includes an ingredient that the user is allergic to. Data structure 2000 includes a Users table 2002, a User Food Allergies table 2004, and a Food Product Ingredients table 2006. Users table 2002 stores records of general information associated with particular users of the service (e.g., food allergy alerts) provided by data provider 218. User Food Allergies table 2004 stores data identifying allergy ingredients (food ingredients to which a user exhibits hypersensitivity) associated with each user of Users table 2002. Finally, Food Product Ingredients table 2006 stores records of ingredients and associated information for a variety of different foods on the market. The records of Users table 2002 have a one-to-many relationship with the records of User Food Allergies table 2004, because each user may suffer several different food allergies. The records of User Food Allergies table 2004 have a one-to-many relationship with the records of Food Product Ingredients table 2006, because a particular allergy ingredient may be found in more than one of the food products of table 2006.

Each record in Users table 2002 includes a “User ID” field 2008, a “User Name” field 2010, a “User Address” field 2012, a “User Phone” field 2014, and a “Status/Active” field 2016. User ID field 2008 is the key field of Users table 2002 and includes data representing a unique identifier for each user record stored therein. User Name field 2010 stores data indicative of the user's name associated with a particular record. User Address field 2012 stores data indicative of the user's address, and User Phone field 2014 stores data indicative of the user's phone number. Finally, Status/Active field 2016 stores data indicating whether or not a particular user is active.

Each record in User Food Allergies table 2004 includes a “User ID” field 2018 and an “Allergy Ingredient ID” field 2020. User ID field 2018 and Allergy Ingredient ID field 2020 are, in combination, key fields and, in combination, form a unique identifier for each record of table 2004. User ID field 2018 stores the same data as User ID field 2008 of Users table 2002, and relates each user food allergies record with a particular user record in table 2002. Allergy Ingredient ID field 2020 contains an identifier of a pre-identified food allergy ingredient associated with a particular user. It should be noted that User Food Allergies table 2004 will contain as many records as necessary to record all the food allergies of each user.

Each record in Food Product Ingredients table 2006 includes a “Food Product ID” field 2022, an “Allergy Ingredient ID” field 2024, a “Food Description” field 2026, and a “Manufacturer” field 2028. Food Product ID field 2022 and Allergy Ingredient ID field 2024 are, in combination, key fields of table 2006 and, in combination, form a unique identifier for each record therein. Food Product ID field 2022 stores a product identifier data indicative of a particular food product. Allergy Ingredient ID field 2024 stores data representing a particular ingredient stored in the associated food product. Food description field 2026 stores a description of the food item associated with each record of table 2006. Manufacturer field 2028 stores data indicative of the manufacturer of the associated food product.

It should be noted that the database tables, or subsets thereof, described in FIG. 20 could also be stored in local products database 926 of PDD 202, such that user 102 would have access to the food allergy information contained therein even when no network connection is available. Indeed, it is conceivable that a user will transfer all records relevant to the particular user's allergies to local products database 926 of the user's PDD 202. Thus, the user will have access to all records relevant to the user's allergies, even when no network access is available.

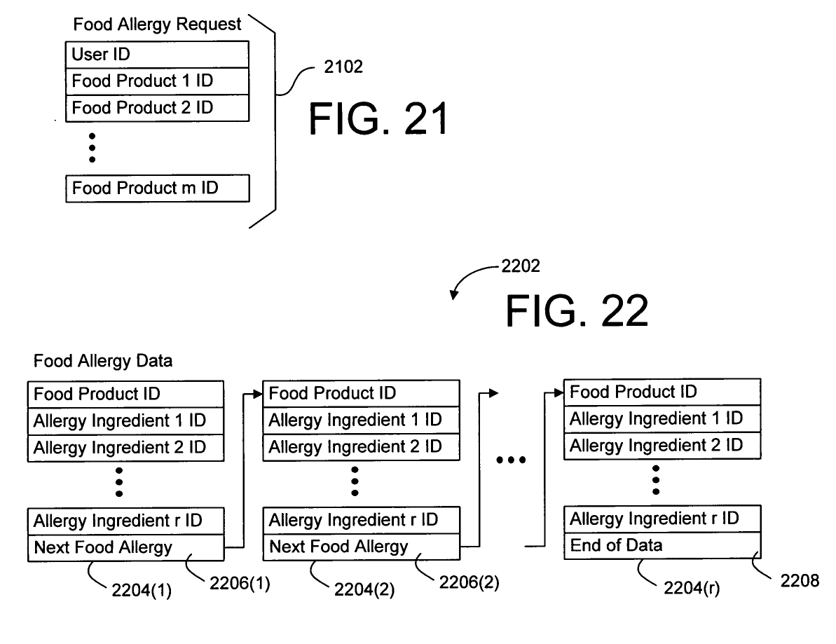

FIG. 21 shows an example data structure for a Food Allergy Request 2102 sent by user 102 to a data providers 218 hosting database 220 including the tables of FIG. 20 stored therein. Food Allergy request 2102 is a query that is transmitted from product information client 918 to product information server 624. Food allergy request 2102 includes data representing a User ID of user 102 and a plurality of food product identifiers, represented as Food Product I ID, Food Product 2 ID, through Food Product m ID. Although multiple food products are shown, it is anticipated that under normal circumstances only one food product will by submitted by user 102 at a time, for example while shopping in a grocery store. Optionally, a user can capture product identifiers from several products (e.g., after shopping) and submit all of the product identifiers in a single food allergy request 2102. Food Allergy Request 2102 can be used by user 102 to submit any number of food products to check for ingredients that they are allergic to.

Responsive to receiving the query, product information server 624 querys database API 622 for records from database 220 for all allergy ingredients contained in the identified food products that have been associated with the user by previously stored user food allergy records. First, API 622 searches User Food Allergies table 2004 for all allergy ingredient IDs 2020 associated with the user ID submitted in the request. Next, API 622 searches Food Product Ingredients table 2006 for all food product records containing a food product ID matching the food product IDs submitted in the request. Finally, API 622 filters the matching food product ingredient records based on the allergy ingredient IDs of the records retrieved from table 2004, and returns the results to product information server 624. Then, product information server 624 transmits the returned food allergy data back to user 102.

Note that the description of this aspect of the invention assumes that database 220 of data provider 218 already includes records associating particular allergy ingredients with user 102 in User Food Allergies table 2004. Product information server 624 and client 918 and/or PDD API 932 provide an interface for users 102 to store records in User Food Allergies table 2004 to associate their user ID 2018 with particular allergy ingredient IDs 2020.

FIG. 22 shows an example structure for Food Allergy Data 2202 that is transmitted from product information server 624 back to product information client 918. Food allergy data 2202 includes a plurality of food allergy records 2204(1-n). Food allergy records 2204(1-n) each include the food product identifier associated therewith (i.e., the product identifier submitted by user 102) and as many allergy ingredients (1-r) as the food product contains which user 102 is allergic to. Each of food allergy records 2204(1-(n−1)) includes a next food allergy field 2206(1-(n−1)) pointing to the next food allergy record 2204 contained in the data 2202. Food allergy record 2204(n) includes an “End of Data” flag 2208, which indicates that there are no further records in food allergy data 2202. Optionally, Food Allergy Request 2202 can contain query parameters to reduce or increase the fields contained in food allergy records 2204(1-n), for example, to include a food description field as well.

It should be noted that the queries and returned data described in FIGS. 21 and 22 are exemplary in nature. Indeed, the queries and data described herein can be modified or new queries and/or data can be provided as needed for a particular application. For example, although not described in detail herein, product information server can receive instructions to register new users or update user information. In addition, an allergy ingredient submission query could be used to store new pre-identified allergy ingredient identifiers in Users Food Allergies table 2004. Further it is anticipated that data templates (not shown) will be used to collect food product ingredients data from manufacturers.

Additionally, it is important to note that the present invention is not limited to food allergies, but is equally applicable to other types of products to which a user might be hypersensitive. For example, this embodiment of the invention can identify chemical components of cleaning products, to which the user is hypersensitive. As another example, the invention can identify components of personal care products, (dermatological creams, hair care products, etc.) to which a user might be hypersensitive.

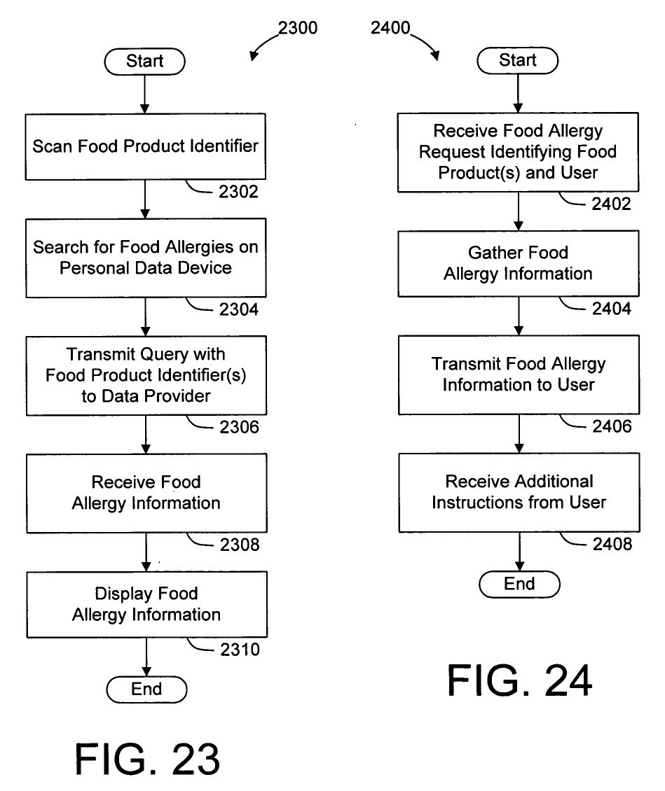

FIG. 23 is a flowchart summarizing one method 2300 for user 102 to obtain food allergy information according to one aspect of the present invention. In a first step 2302, user 102 captures one or more food product identifiers (e.g., a UPC barcode, etc.) identifying a food product using product ID scanner 910. Next, in a second step 2304 product information client 918 querys local products database 926 of PDD 202 for food allergy information associated with the captured food product identifier and with user 102. Then, in a third step 2306, responsive to instructions from user 102, product information client transmits a query including the food product identifier(s) and a user ID to product information server 624 via internet 214. Next, in a fourth step 2308, PDD 202 receives food allergy data 2202 from product information server 624. Optionally, in third step 2306 and fourth step 2308, product information client 918 can interact directly with product information database 220 via PDD API 932. Finally, in a fifth step 2310, PDD 202 displays the food allergy information contained in food allergy report 2202 to user 102 via GUI 934 and user I/O device(s) 906.

FIG. 24 is a flowchart summarizing one method 2400 for providing food allergy information to a user 102 according to one aspect of the present invention. In a first step 2402, product information server 624 receives a food allergy request 2102 identifying a particular user and at least one food product. Then, in a second step 2402, product information server 624 querys product information database 220, via database API 622, for all records associated with both the identified user and the identified food product(s). Next, in a third step 2406, product information server 624 transmits the data returned by API 622 to product information client 918. Finally, in a fourth step 2408, product information server receives any additional instructions from PDD 202, for example, a connection termination, another food allergy request, etc.

The present embodiment of the invention provides the advantage that it allows user 102 to determine if a food product contains ingredients that he/she is allergic to. This would be especially useful in supermarkets and fast food restaurants to quickly determine if a food contains allergy ingredients. It should be noted that, in addition to food manufacturers, restaurants, caterers, and other sources of food (analogous to retailers 216) can provide food product ingredient data to data providers 218 and provide food product identifiers (e.g., on menus) that can be captured by customers.

In another embodiment (data structures not shown), a user can store records associating particular food allergies with other people (e.g., friends, family members, etc.). This embodiment would be particularly useful, for example, when hosting a meal for others. When shopping or preparing the meal, the user could check the food products to ensure that the meal will not pose an allergy problem to one or more of the guests. Similarly, the primary shopper for a family can watch out for foods that would pose an allergy problem to any member of the family.

It should be noted that User Food Allergies table 2004 is optional. For example, a User Food Allergies table could be maintained only on PDD 220, so that personal medical information need not be transmitted to data providers 218. In that case, data providers 218, instead of matching allergy ingredients of a user with food product ingredients, would provide only an ingredients list to user 102. Then, information handler 930 would filter the ingredients list based on a food allergies table (not shown) stored in database 926 of PDD 202.

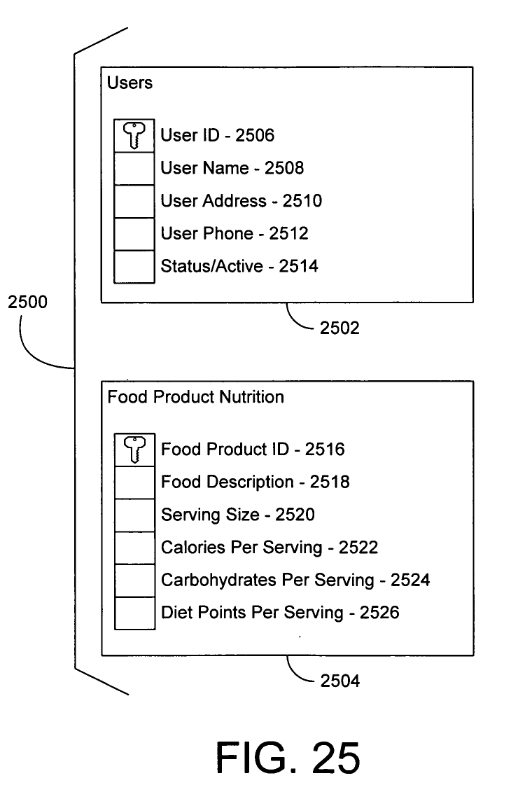

FIG. 25 shows a data structure 2500 useful for storing data related to food nutrition in product information database 220. Data structure 2500 includes a Users table 2502 and a Food Product Nutrition table 2504. Users table 2502 stores records of general information related to particular subscribers of the food nutrition service provided by data provider 218. Food Product Nutrition table 2504 stores nutritional information for various food products.

Each record in Users table 2502 includes a “User ID” field 2506, a “User Name” field 2508, a “User Address” field 2510, a “User Phone” field 2512, and a “Status/Active” field 2514. User ID field 2506 is the key field of Users table 2502 and includes data representing a unique identifier for each user record stored therein. User Name field 2508 stores data indicative of the user's name associated with a particular record. User Address field 2510 stores data indicative of the user's address, and User Phone field 2512 stores data indicative of the user's phone number. Finally, Status/Active field 2514 stores data (e.g., a single bit flag) indicating whether the user's account is active or inactive.

Each record in Food Product Nutrition table 2504 includes a “Food Product ID” field 2516, a “Food Description” field 2518, a “Serving Size” field 2520, a “Calories Per Serving” field 2522, a “Carbohydrates Per Serving” field 2524, and a “Diet Points Per Serving” field 2526. Food Product ID field 2516 is the key field of table 2504 and contains data representing a unique identifier for each food product record in table 2504. Food description field 2518 stores a description of the food item associated with each record of table 2506. Serving Size field 2520 stores data indicative of a serving size (portion size) of the food product associated with each record of table 2504. Calories Per Serving field 2522 stores data indicative of the calories contained in each serving of the food product. Carbohydrates Per Serving field 2524 stores data indicative of the grams of carbohydrates in each serving of the food product. Finally, Diet Points Per Serving field 2526 stores data indicative of a particular diet point value (e.g., Weight Watchers™ or other diet program) for each serving of the food product. It should be understood that the particular nutrition fields shown are not intended to be an exhaustive list of all possible types of data. For example, additional fields containing data indicative of other nutritional values (e.g., fiber content, vitamin information, percent of daily recommended value, etc.) or food product attributes (e.g., kosher) can be added as desired.

It should be noted that the database tables described in FIG. 25, or a subset thereof, can also be stored in local products database 1026 of personal data device 202 such that the food product nutrition information contained therein will be accessible to user 102 even when no network access is available.

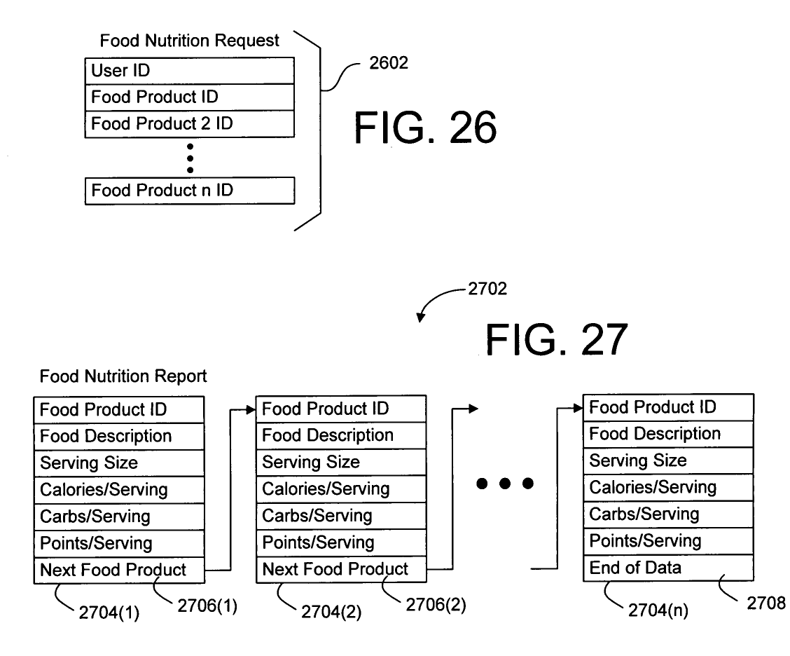

FIG. 26 shows an example data structure for a Food Nutrition Request 2602, which is sent by user 102 to a data provider 218 having the tables of FIG. 25 stored in product information database 220. Food Nutrition request 2602 is a query submitted by product information client 918 that causes product information server 624 to retrieve relevant product information, in this case food nutrition information, from database 220, and transmit the food nutrition information back to user 102. Food nutrition request 2602 includes data representing a User ID of user 102 and a plurality of Food Product identifiers, represented as Food Product 1 ID, Food Product 2 ID, through Food Product m ID. Although shown to include multiple food product identifiers, it should be understood that Food Nutrition Request 2602 can include only one food product identifier.

FIG. 27 shows an example data structure for Food Nutrition Data 2702 provided to user 102 from data provider 218 responsive to a food nutrition request 2602. Food nutrition data 2702 includes one or more Food Products records 2704(1-n), each corresponding to a respective food product ID of food nutrition request 2602. Further, although particular fields can be filtered depending on user preferences, the fields of food products records 2704 generally correspond the fields of table 2504. Food Products 2704(1-n) contain nutritional information for each food product submitted by user 102, which is read from Food Product Nutrition table 2504. For example, each food product record 2704(1-n) in data 2702 contains serving size, calories per serving, carbohydrates per serving, and points per serving information. Each of food product records 2704(1-(n−1)) in data 2702 includes a next food product field 2706(1-(n−1)) pointing to the next food product record 2704 contained in data 2702. Food product record 2704(n) includes an “End of Data” flag 2708, which indicates that there are no more records in food nutrition data 2702. Finally, Food Nutrition Request 2602 can include user adjustable parameters to reduce or expand the number of fields included in Food Products records 2704(1-n) of Food Nutrition Data 2702, for example, to only display the calories per serving or diet point values from one of a plurality of different diet plans.

It should be noted that the query and data structures described in FIGS. 26 and 27 are exemplary in nature. As indicated above with respect to other disclosed embodiments, the queries and data structures shown herein for illustrative purposes can be modified and/or augmented as necessary or desirable.

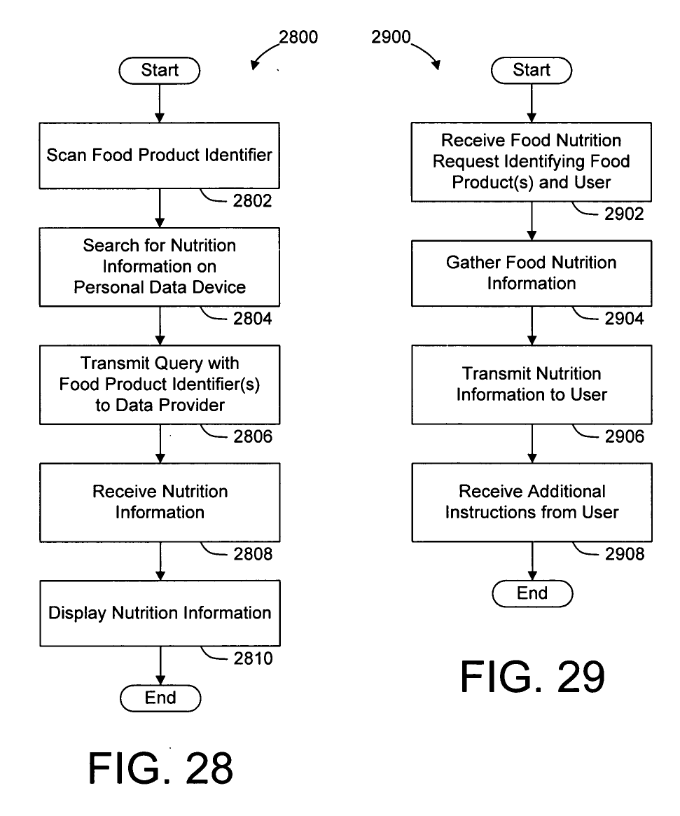

FIG. 28 is a flowchart summarizing one method 2800 for obtaining food nutrition information according to the present invention. In a first step 2802, user 102 captures a food product identifier (e.g., a UPC barcode, etc.) identifying the food product using product ID scanner 910. Optionally, user 102 can capture multiple food product identifiers if so desired. Then, in a second step 2804, product information client 918 querys local database 926 for records associated with the scanned food product identifier(s). Next, in a third step 2806, product information client 918 transmits a query including one or more Food Product Identifiers (e.g., food allergy request 2602) to product information server 624 of data provider 218. Then in a fourth step 2808, product information client 918 receives food nutrition data 2702 from product information server 624. Optionally, in third step 2806 and fourth step 2808, product information client can query database 220 of data provider 218 via PDD API 932. Finally, in a fifth step 2810, PDD 202 displays the received food nutrition information, via GUI 934 and user I/O device(s) 908 to user 102.

FIG. 29 is a flowchart summarizing one method 2900 for providing food nutrition information to a user 102 according to the present invention. In a first step 2902, product information server 624 receives a food nutrition request 2602 including at least one food product identifier and a user identifier. Then, in a second step 2904, product information server 624 querys product information database 220 for records associated with the food identifier(s) included in the received food nutrition request 2602. Next, in a third step 2906, product information server 624 transmits the data returned by database 220 to product information client 918. Finally, in a fourth step 2908, product information server 624 receives additional instructions from product information client 918, for example, a connection termination, another food nutrition request, etc.

It should be noted that any type of nutrition information can be stored in Food Product Nutrition table 2504. For example, Food Product Nutrition table 2504 can include a “Net Carbohydrates Per Serving” field in which the manufacturers of particular foods submit a “net carbohydrates” value used, for example, by people on the Atkins™ Diet. As another example, database 220 of data provider 218 can include a table for user 102 to store records of their food intake. For example, user 102 could store daily counts of their carbohydrate and/or diet plan points intake. As another example, food nutrition request 2602 can include a “Number of Servings Consumed” field such that database 620 could automatically store food intake information for user 102 on a daily basis. An advantage of this particular embodiment of the present invention is that it allows user 102 to easily keep track of their nutritional intake. For example, restaurants could place product identifiers on their menu or elsewhere so that user 102 could scan the product identifier and immediately know the nutrition information associated with a particular meal. Finally, similar to the other embodiments disclosed herein, data provider 218 is capable of receiving food nutrition updates from food manufacturers to keep database 220 up to date.

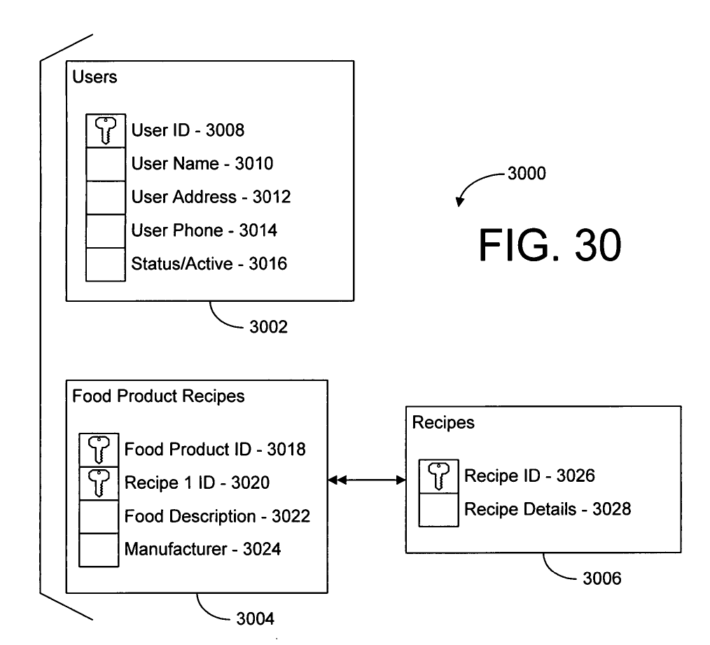

FIG. 30 shows an example data structure 3000 useful for storing recipe data in product information database 220. Data structure 3000 includes a Users table 3002, a Food Product Recipes table 3004, and a Recipes table 3006. Users table 3002 stores records of general information associated with particular subscribers of the service (recipe service) provided by data provider 218. Food Product Recipes table 3004 stores records, each associating a recipe to a particular food product. Recipes table 3006 contains records storing recipe instructions/details for a large number of recipes. The records of Recipes table 3006 have a one-to-many relationship with the records of Food Products Recipes table 3004, because each recipe record will be related to several food products that are the ingredients of the recipe.

Each record in Users table 3002 includes a “User ID” field 3008, a “User Name” field 3010, a “User Address” field 3012, a “User Phone” field 3014, and a “Status/Active” field 3016. User ID field 3008 is the key field of Users table 3002 and includes data representing a unique identifier for each user record stored therein. User Name field 3010 stores data indicative of the user's name associated with a particular record. User Address field 3012 stores data indicative of the user's address, and User Phone field 3014 stores data indicative of the user's phone number. Finally, Status/Active field 3016 stores data (e.g., a single bit flag) indicating whether the user's account is active (high) or inactive (low).

Each record in Food Product Recipes table 3004 includes a “Food Product ID” field 3018, a “Recipe ID” field 3020, a “Food Description” field 3022, and a “Manufacturer” field 3024. Food Product ID field 3018 and Recipe ID field 3020, in combination, are the key fields of table 3004 and, together, contain data that provides a unique identifier for each food product recipe record in table 3004. Food Product ID field 3018 stores data uniquely identifying a particular food product. Recipe ID field 3020 stores data uniquely identifying a particular recipe record of Recipes table 3006. Food description field 3022 stores a description of the food product associated with each record of table 3004, and Manufacture field 3024 stores data identifying the manufacturer of the food product associated each record of table 3004.

Each record in Recipes table 3006 includes a “Recipe ID” field 3026 and a “Recipe Details” field 3028. Recipe ID field 3026 is the key field of Recipes table 3006 and contains data uniquely identifying each record stored therein. Recipe Description field 3028 stores the recipe details and instruction information for each particular recipe record of table 3006. In the present embodiment, Recipe Description field 3028 stores data indicative of each ingredient of the recipe, the quantity of each ingredient, and the recipe's mixing and preparation directions.

It should be noted that the database tables described in FIG. 30 could also be stored in local products database 1026 of personal data device 202, such that the recipe information contained therein would be readily accessible to user 102, as described above with reference to other data provision services.

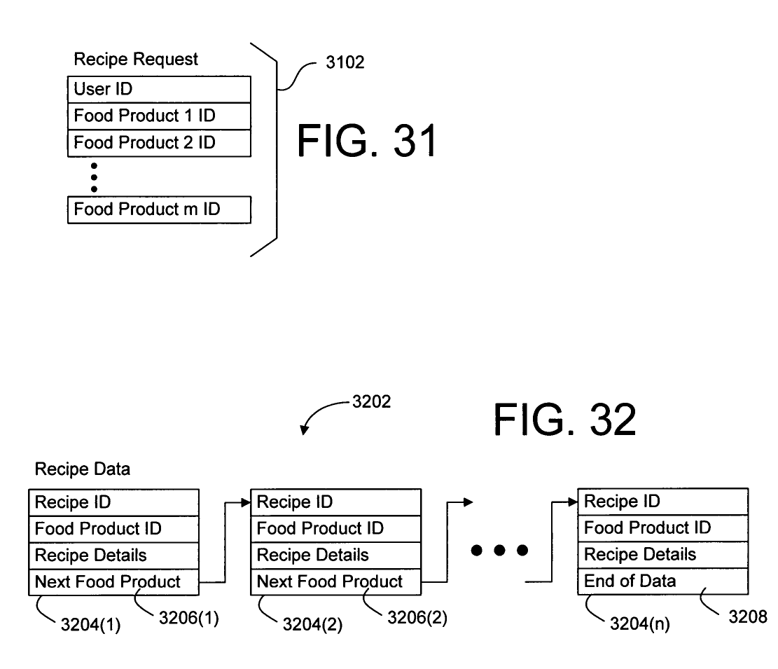

FIG. 31 shows an example data structure for a Recipe Request 3102, sent by user 102 to a data provider 218 hosting a database 220 including the tables of FIG. 30. Recipe request 3102 is a query that causes data provider 218 to gather recipes associated with the included food product identifiers, and transmit the recipes back to user 102. Recipe request 3102 includes data representing a User ID associated with user 102 and one or more Food Product identifiers, shown as Food Product 1 ID, Food Product 2 ID, through Food Product m ID. Although recipe request 3102 can include more than one food product identifier, it is expected that recipe request 3102 will more often include a single main ingredient. One possible exception will be when a user wants to search for a single recipe that includes a particular combination of food products. In that case, a custom query can be used to return only those recipes including all of the identified food products. Alternatively, recipe request 3102 can be used to return all recipes including any of the identified food products, then the returned records can be sorted to obtain only those recipes including all of the identified food products.

Recipe Request 3102 is used to submit one or more food product identifiers to obtain recipes containing those foods. For example, a user can capture a product ID on a container of oats, and then transmit a recipe request 3102 including the product ID to obtain recipes (e.g., oatmeal cookies) which include the oatmeal. As used herein, the term “recipe” is understood to include preparation instructions for food products, even if the preparation does not include mixing more than one food product.

FIG. 32 shows Recipe data 3202 provided to user 102 from data provider 218 in response to receiving recipe request 3102. Recipe data 3202 includes a plurality of recipe records 3204(1-n), each containing a food identified by one of the Food Product IDs in the recipe request 3102. Recipes 3204(1-n) also contain data indicative of the recipe's details (ingredients and quantity, mixing directions, cooking directions, etc.) from the associated record of recipes table 3006. Each of recipes 3204(1-(n−1)) in report 3202 includes a next recipe field 3206(1-(n−1)) pointing to the next recipe record 3204 of data 3202. Recipe 3204(n) includes an “End of Data” flag 3208, which indicates that there are no more records in recipe data 3202.

It should be noted that the query and data structures described in FIGS. 31 and 32 are exemplary in nature. As indicated above with respect to other disclosed embodiments, the queries and data structures shown herein for illustrative purposes can be modified and/or augmented as necessary or desirable. For example, in response to receiving a recipe request including a plurality of food product identifiers, product information server 624, responsive to a user command or parameter, can provide only those recipes that include all of the identified food products. As another example, instead of providing recipes in response to receiving a food product identifier, product information server 624 can provide a list of ingredients in response to receiving a recipe identifier, which might be captured from a display in a grocery store.

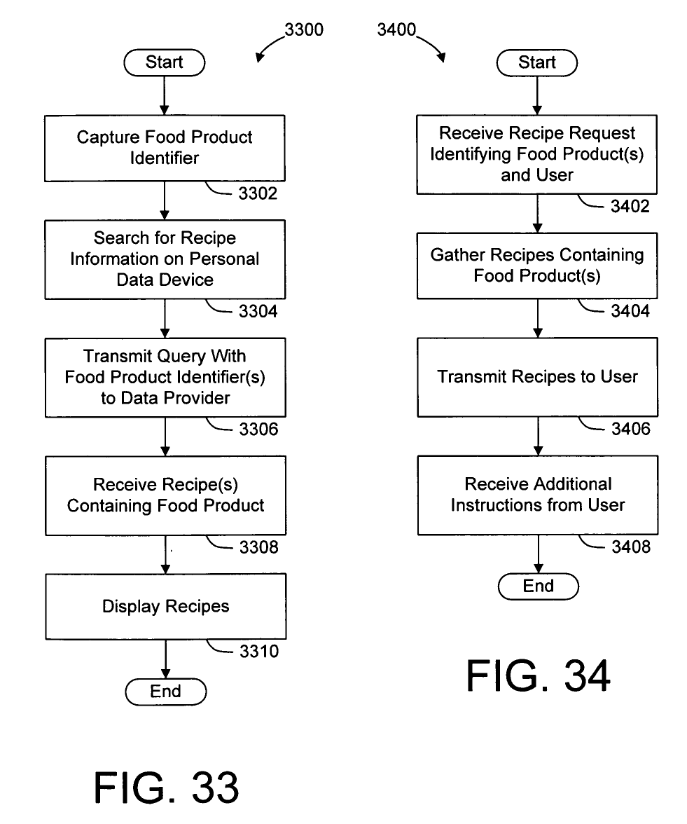

FIG. 33 is a flowchart summarizing one method 3300 for obtaining recipes according to the present invention. In a first step 3302, user 102 captures at least one food product identifier identifying at least one particular food product with product ID scanner 910. Then, in a second step 3304, product information client 918 querys local products database 926 for recipes associated with the captured food product identifier(s). Next, in a third step 3306, responsive to instructions from user 102, product information client 918 transmits recipe request 3102 to product information server 624 of data provider 218. Then, in a fourth step 3308, product information client 918 receives recipe data 3202 from product information server 624. Finally, in a fifth step 3310, product information client 918 displays the recipe data 3202 to user 102, via GUI 934 and user I/O 906 of PDD 202.

FIG. 34 is a flowchart summarizing one method 3400 for providing recipe information to user 102 according to the present invention. In a first step 3402, product information server 624 of data provider 218 receives a recipe request 3102, including a captured food product identifier and a user ID, from PDD 202. Then, in a second step 3104, product information server 624 querys database 220 for recipe records associated with the captured food product identifier. Next, in a third step 3406, product information server 624 transmits the returned recipe data 3202 to user 102 via product information client 918, GUI 934, and user I/O devices 906. Finally, in a fourth step 3408, data provider 218 receives additional instructions from PDD 202, for example, a connection termination, another food recipe request, etc.

The presently described embodiment of the invention allows a user 102 to quickly obtain recipes including particular food products. This is especially useful while in a supermarket, because user 202 can find a new recipe and purchase any other required ingredients while still at the supermarket. Additionally, user 102 can scan a food product while at home and generate a shopping list of the ingredients of a recipe associated with the food product.

The particular types of data stored in database 220 by data provider 218 can also be modified without departing from the scope of the invention. For example, database 220 can include a table identifying user 102's favorite recipes. Further, data provider 218 can receive new or updated recipes from food manufacturers, for example as part of a promotion of their food product.

The description of the various data services of the present invention is now complete. It should be noted that these particular embodiments can be modified or combined to provide additional useful embodiments of the present invention. For example, the drug interaction data service can be modified to provide drug allergy information in addition to drug interaction information. Indeed, a single data provider 218 can host any combination of the data services described herein. Further, although a separate users table is disclosed in the description of each type of service, a single users table including a status flag for each type of service could be used in embodiments combining multiple services.

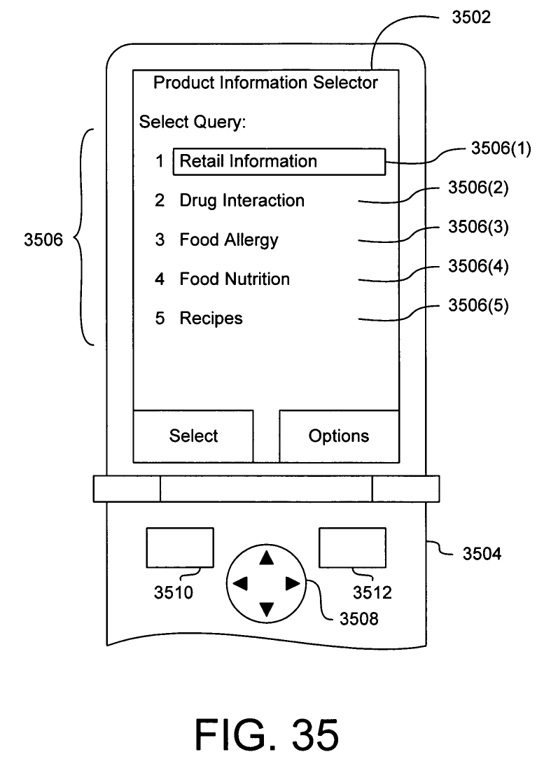

FIG. 35 shows a particular example of graphical user interface 934 included with, for example, a cellular camera phone 204. User interface 934 presents to user 102 and facilitates the selection of a desired information query, such as those previously described herein, to request data from a data provider 102.

Camera phone 204 includes a display 3502 and a keypad 3504. Display 3502, in the present embodiment, is an LCD display showing a “Product Information Selector” graphical interface that presents multiple information query selectors 3506(1-5) to user 102. Each of selectors 3506(1-5) correspond to particular type of product information request described previously herein. Selecting Retail Information selector 3506(1) would cause phone 204 to begin processing a retail information request. Selecting Drug Interaction selector 3506(2) would cause phone 204 to begin processing a drug interaction request. Selecting Food Allergy selector 3506(3) would cause phone 204 to begin processing a food allergy request. Selecting Food Nutrition selector 3506(4) would cause phone 204 to begin processing a food nutrition request, and, finally, selecting Recipes selector 3506(5) would cause phone 204 to begin processing a recipes request.

User 102 can scroll through each selector 3506(1-5) using a directional pad 3508 of keypad 3504. A highlighted selector 3506(1-5) indicates that a particular selector 3506(1-5) can be selected. To activate the selector 3506, user 102 presses a “Select” button 3510 on keypad 3504. In the present example, user 102 selects Retail Information selector 3506(1) (highlighted) such that he/she can submit a retail product information request to a data provider 218.

An “Options” button 3512 is also shown. Options button 3512 allows user 102 to access optional graphical user interfaces associated with each query identified by selectors 3506(1-5). For example, when Drug Interaction selector 3506(2) is chosen (highlighted) user 102 can press options button 3512 to access a pre-identified drugs screen. This screen (not shown) allows user 102 to enter drugs or drug identifiers that he/she is currently taking so that the drugs can be transmitted to data center 218. Similarly, by pressing options button 3512 when Food Allergy selector 3506(3) is highlighted, user 102 accesses a pre-identified food allergies screen (not shown), wherein user 102 can enter pre-identified food allergy ingredients and/or identifiers for submission to data provider 218. Another optional screen (not shown) allows user 102 to update personal information with a particular data provider 218. These and other interfaces should be apparent from the disclosure of the present invention.

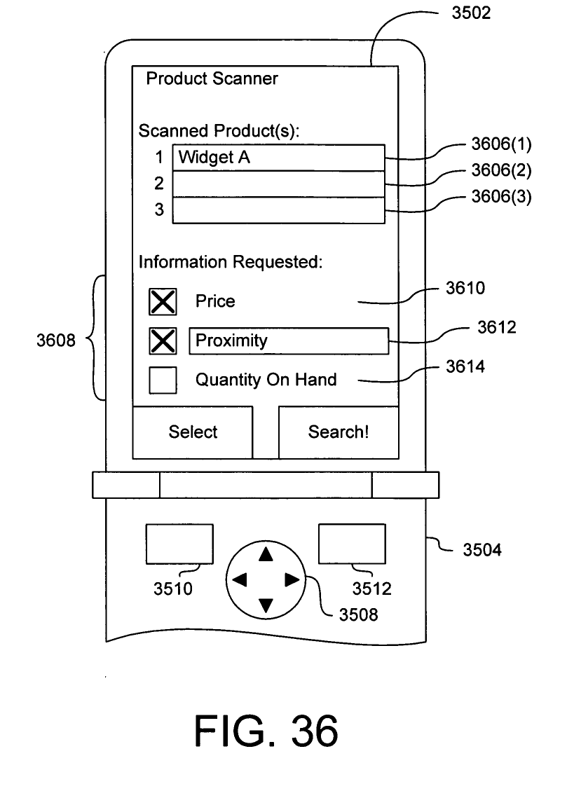

FIG. 36 shows another particular screen generated by graphical user interface 934 that is used by camera phone 204 after an information request has been selected and a product identifier has been captured. This screen includes a plurality (3 in this example) of “Scanned Product” fields 3606(1-3), which display scanned product identifiers to user 102. In the present embodiment, only a single product identifier has been scanned, and accordingly Scanned Product field 3606(1) contains an identifier (e.g., a decoded UPC, a name identifier input by user 102, etc.) for “Widget A.” Directional pad 3508 facilitates scrolling through the captured product identifiers in case the number of captured identifiers exceeds the number of fields 3606 provided.

Display 3502 also shows several “Information Requested” parameter fields 3608, which allow user 102 to define what information is requested from data provider 218 by selecting particular information parameters. In the present embodiment, Information Requested fields 3608 include a “Price” parameter 3610, a “Proximity” parameter 3612, and a “Quantity On Hand” parameter 3614. Price parameter 3610 indicates that user 102 requests price information for each scanned product 3606. Proximity parameter 3612 indicates that user 102 requests proximity information indicating the location of a retailer associated with each scanned product 3606. Finally, Quantity On Hand parameter 3614 indicates that user 102 requests the quantity of the identified product that each retailer has on hand.

Parameters 3610, 3612, and 3614 can be navigated using a directional pad 3508. An active field is highlighted, and in the present embodiment, Proximity parameter 3612 is highlighted and can be toggled between selected and unselected states. Select button 3510 toggles each of parameters 3610, 3612, and 3614 between their selected and unselected states, when the particular parameter is highlighted. In the present example, price parameter 3610 and proximity parameter 3612 are shown to be selected. When the appropriate parameters have been set, activating button 3512 (now labeled “Search!”) causes camera phone 204 to generate a product information requests 702 and transmit the request to one or more corresponding data providers 218(1-n). Parameters 3610, 3612, and 3614 are optionally submitted with product information request 702 and define the information contained in product information data 706 returned by the data provider(s) 218.

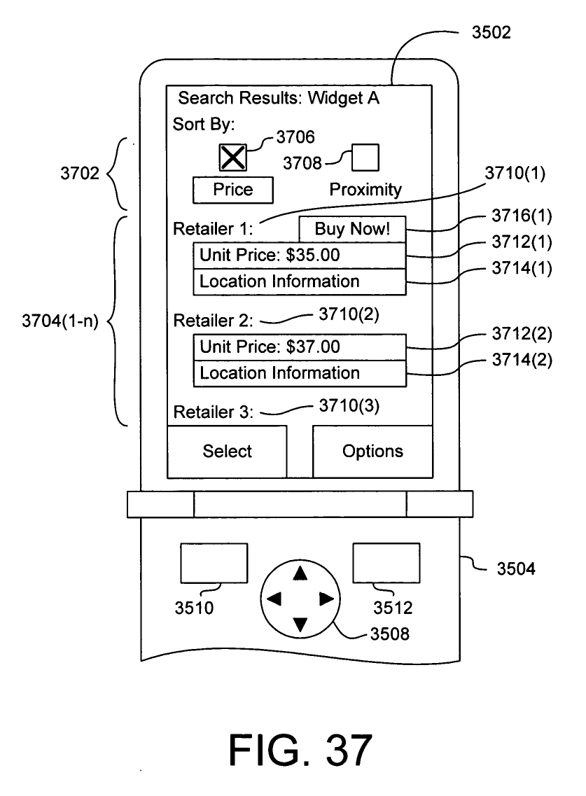

FIG. 37 depicts another screen of GUI 934, showing the returned search results for the product “Widget A.” The results presented on display 3502 are obtained from the product information data (e.g., product information data 706) received by camera phone 204 from a data provider 218.

Display 3502 shows a plurality of “Sort By” criteria 3702 and a plurality of “Retailer Information” fields 3704. “Sort By” criteria 3702 allow user 102 to sort the results displayed by a selected criteria. Retailer Information fields 3704(1-n) display retailer information associated with the scanned product.

“Sort By” criteria 3702 include a “Price” criteria 3706 and a “Proximity” criteria 3708. When Price criteria 3706 is selected, retailer fields 3704 will be displayed in ascending order by price (e.g., lowest price to highest price). When Proximity criteria 3708 is selected, retailer fields 3704 will be displayed in order from nearest proximity to furthest proximity with respect to camera phone 204. When both Price criteria 3706 and Proximity criteria 3708 are selected, retailer fields 3704 will be displayed by price and proximity. For example, Retailer fields 3704 might be arranged from lowest to highest price according to their proximity to phone 204 within concentric rings having diameters incremented by one mile. In such a case, the retailers within a one-mile radius would be displayed first from lowest to highest price, then the retailers within a two-mile radius would be displayed second from lowest to highest price, and so on. In the event that Quantity On Hand parameter 3614 was selected, user 102 could sort retailers by quantity on hand as well.

Each of retailer information fields 3704 (only two shown complete) include a “Retailer” field 3710, a “Unit Price” field 3712 and a “Location Information” field 3714. Retailer field 3710 displays a retailer contained in product information report 706 by name. Unit price field 3712 displays the price per unit of Widget A for a particular retailer. Location information field 3714 displays the location of each retailer associated with Retailer field 3710. Note that when there are more retailer information fields (records) to be displayed than will fit on display 3502, directional pad 3508 can be used to scroll through the records.

Note that some (only one shown) Retailer Information fields 3704 associated with particular retailers 216 (e.g., Retailer 1) include a “Buy Now” field 3716. Buy Now field 3716 indicates that the product associated with that particular retailer can be purchased via camera phone 204. Selecting “Buy Now” field 3716 causes camera phone 204 to transmit a purchase request 704 to data provider 218 or manufacturer 216, as described above with respect to FIG. 7A and FIG. 7B.

Additional graphical user interfaces will be apparent in view of the present disclosure. For example, retailers associated with Retailer fields 3710(1-n) can be superimposed over a map according to location, such that the position of camera phone 204 can be tracked with respect to the retailers by position detector 928. Additionally, it should be understood that GUI 934 includes screens (not shown) to present all data indicated herein to be presented to user 102 and to accept all selections/user instructions indicated herein to be received by user 102. Such screens of GUI 934, although not shown explicitly, can be gleaned from the description of the operation of the present invention and are considered to be aspects of the present invention.

The description of particular embodiments of the present invention is now complete. Many of the described features may be substituted, altered or omitted without departing from the scope of the invention. For example, alternate databases (e.g., databases that correlate International Standard Book Numbering codes with libraries or book stores that contain the associated book), may be substituted for or augment the described tables of database 220. As another example, the various product information tables, queries, and returned data described herein can contain alternate information (i.e., different fields) and/or parameters to limit or expand the information contained in the returned product information data. In addition, the particular steps described in the flowcharts discussed herein can be altered or omitted, and any one step should not be considered essential. As still another example, the functions and/or information of the databases described herein could be directly loaded into a personal data device via a home computer or other mass data storage device or media.

Note also that a query can be used to identify acceptable substitutes for an identified product. For example, if a user determines via a drug interaction query that a particular analgesic is unacceptable due to a drug interaction, allergy, or some other reason, then the database can be searched for other acceptable analgesics. Of course, to implement this aspect of the invention, the records of the database(s) would include fields associating acceptable substitutes for particular products. This feature can be implemented with any of the described embodiments of the invention.

Another useful feature of the present invention is that responsive to a list of product identifiers, a data provider can provide data associating retailers with the respective retailer's total price for all the products identified. This feature allows a consumer to create a shopping list of product identifiers, and then query the data provider to determine the best place to shop to get the lowest total price at a single location.

When a PDD with multimedia capability is used, the invention can return multimedia data in response to a query. For example, responsive to a product identifier associated with a particular music recording, the system can return samples of the content of the recording (e.g., snippets of songs included on a compact disc). In the case of a video recording product, the system can return a video sample (e.g., a movie trailer) that the user can view. Other information that can be returned responsive to receipt of a product identifier associated with an audio or video product includes, but is not limited to, a list of songs on a recording, a list of other works by the same artist(s), a link to an artist's web site, a concert schedule, a video concert clip, a list of artists/works that are enjoyed by those who enjoy the identified work/artist, samples of a movie soundtrack, and a list of a movie cast.

In addition to the previously described aspects of the invention, there are additional business method aspects of the invention. For example, in response to a retail information query, a special promotional price can be offered to the user. For example, a digital coupon can be transmitted to the user. This aspect of the invention can be implemented in a number of ways including, but not limited to, printing out a coupon, displaying a machine readable image on a display of the PDD, providing a communications device in the PDD to facilitate communication with a register of a retailer, and providing a promotional code. This aspect of the invention can also be used in conjunction with the position detection feature of the invention by, for example, offering different promotions to a user depending on whether the user is currently present in a particular retailer's establishment.

An option can also be offered to retailers to receive feedback on searches associated with products they offer. The feedback can be provided for a fee or as compensation for keeping data in the products database(s) up to date. The feedback to retailers can occur periodically or in near real time. For example, in combination with the position detection feature, immediate feedback can be provided to a retailer to alert the retailer that a potential customer currently present in their establishment has submitted a query associated with one of the retailer's products/services. Additionally, the system can assist the manufacture in providing sales information to the user, either directly or via the data provider. The user may optionally block any undesired sales materials or ads. As yet another example, the system can use a captured product identifier to establish a direct connection with the manufacturer/retailer, such as a telephone connection to ask questions about the identified product.

In another embodiment, the system and method of the present invention can be used to check compatibility between two identified products. For example, certain vehicles require certain fluid types, different cameras require different batteries, and so on. After capturing a first product identifier, the database can be queried to determine whether the product associated with the identifier (e.g., the batteries) is compatible with another product (e.g., a camera) associated with a second product identifier provided earlier or contemporaneously with the first product identifier. Alternatively, responsive to a query including one product identifier, the system can return a list of compatible products.

These and other deviations from the particular embodiments shown will be apparent to those skilled in the art, particularly in view of the foregoing disclosure, and are considered to be aspects of the present invention.

I claim:

1. A method for using product identifiers, said method comprising:
capturing a product identifier associated with a product;
receiving a user's selection of one of a plurality of queries;
transmitting said product identifier and said selected query to a data provider;
receiving a response to said selected query from said data provider.

2. A method for using product identifiers according to claim 1, wherein capturing said product identifier includes:
optically reading a barcode; and
decoding said barcode.

3. A method for using product identifiers according to claim 1, wherein capturing said product identifier includes receiving a radio signal from an RFID device.

4. A method for using product identifiers according to claim 1, wherein capturing said product identifier includes receiving said product identifier via a manual input device.

5. A method for using product identifiers according to claim 1, wherein said selected one of said queries is a retail information query.

6. A method for using product identifiers according to claim 5, wherein receiving said response to said selected query includes receiving retail information data associated with at least one retailer selling said product.

7. A method for using product identifiers according to claim 6, wherein transmitting said product identifier and said selected query to said data provider further includes transmitting a geographical location to said data provider.

8. A method for using product identifiers according to claim 7, wherein said retail information data contains data associated with at least one retailer selling within a predetermined distance of said geographical location.

9. A method for using product identifiers according to claim 6, further comprising
selecting a purchase request; and
transmitting said product identifier and said purchase request to said retailer.

10. A method for using product identifiers according to claim 9, wherein transmitting said product identifier and said purchase request to said retailer includes transmitting said product identifier and said purchase request to said retailer via said data provider.

11. A method for using product identifiers according to claim 1, wherein:
said product identifier is a drug identifier; and
said one of said plurality of queries includes a drug interaction query.

12. A method for using product identifiers according to claim 11, wherein receiving said response to said selected query includes receiving a drug interaction report having data therein associated with at least one drug interaction between a drug identified by said drug identifier and at least one other drug associated with said user by a record stored by said data provider.

13. A method for using product identifiers according to claim 11, further including transmitting storage instructions for causing said data provider to store a record associating said drug identifier with said user.

14. A method for using product identifiers according to claim 11, further comprising:
capturing a plurality of drug identifiers; and
transmitting said plurality of drug identifiers and said drug interaction query to said data provider; and wherein
receiving said response to said selected query includes receiving a drug interaction report having data therein associated with at least one drug interaction between any combination of drugs identified by said plurality of drug identifiers.

15. A method for using product identifiers according to claim 1, wherein:
said product identifier is a food identifier identifying a food product; and
said one of said plurality of queries includes a food allergy query.

16. A method for using product identifiers according to claim 15, wherein receiving said response to said selected query includes receiving data including at least one ingredient identifier associated with an ingredient of said food product, said ingredient associated with an allergy of said user by a record stored by said data provider.

17. A method for using product identifiers according to claim 15, further comprising:
capturing at least one allergy ingredient identifier;
transmitting storage instructions causing said data provider to store a record associating said at least one allergy ingredient identifier with said user.

18. A method for using product identifiers according to claim 1, wherein:
said product identifier is a food identifier; and
said one of said plurality of queries includes a food nutrition query.

19. A method for using product identifiers according to claim 18, wherein receiving said response includes receiving a nutrition report having nutrition information stored therein associated with a food product identified by said food identifier.

20. A method for using product identifiers according to claim 1, wherein:
said product identifier is a food identifier; and
said one of said plurality of queries includes a recipe query.

21. A method for using product identifiers according to claim 20, wherein receiving said response to said selected query includes receiving at least one recipe including a food product associated with said food identifier.

22. A method for using product identifiers according to claim 1, wherein transmitting said product identifier and said selected query to said data provider includes transmitting said product identifier and said selected query to said data provider via a third party.

23. A method for using product identifiers according to claim 22, wherein said third party is a mobile telephone company.

24. A method for using product identifiers according to claim 1, further comprising displaying the information contained in said response to said user.

25. A method for using product identifiers according to claim 24, further comprising:
receiving said user's selection of at least one sort parameter; and
sorting said information according to said at least one sort parameter prior to said step of displaying said information.

26. A method for using product identifiers according to claim 25, wherein:
said one of said plurality of queries includes a retail information query;
receiving said response to said selected query includes receiving a retail information report containing retail data associated with at least one retailer selling said product;
said retail data includes one or more of a price of said product associated with said product identifier, a location of said at least one retailer selling said product, and a quantity of said product said retailer has on hand; and
said at least one sort parameter includes one or more of said price, said location, and said quantity.

27. A method for using product identifiers according to claim 26, wherein said at least one sort parameter includes price and location.

28. A method for using product identifiers according to claim 1, wherein said step of transmitting said product identifier and said selected query to said data provider includes:
transferring at least a portion of a database from said data provider to a local device; and
querying said database on said local device.

29. A method for using product identifiers according to claim 1, further comprising storing said response to said selected query.

30. A method for using product identifiers according to claim 1, further comprising:
receiving a storage parameter; and
transmitting said storage parameter to said data provider to cause said data provider to store said product identifier.

31. A method for using product identifiers according to claim 1, further comprising receiving said user's selection of one of a plurality of parameters, said parameters operative to at least partially define the content of said response.

32. An electronically readable medium having code embodied therein for causing an electronic device to perform the method of claim 1.

33. A system for using a product identifier, said system comprising:
a network interface;
a scanner operative to capture a product identifier associated with a product;
a user interface operative to receive a query selection from a user; and
a control module operative
to associate said product identifier and said selected query,
to transmit said product identifier and said selected query to a data provider via said network interface, and
to receive a response to said selected query from said data provider via said network interface.

34. A system for using a product identifier according to claim 33, wherein said scanner includes a digital camera operative to capture a photograph of said product identifier.

35. A system for using a product identifier according to claim 33, wherein said scanner includes a radio receiver operative to receive a radio frequency identifying said product.

36. A system for using a product identifier according to claim 33, wherein:
said user interface is operative to receive a product identifier input by said user; and
said scanner is operative to capture said product identifier input by said user.

37. A system for using product identifiers according to claim 33, wherein said selected query is a retail information query.

38. A system for using product identifiers according to claim 37, wherein said response includes retail information data associated with at least one retailer selling said product identified by said product identifier.

39. A system for using product identifiers according to claim 38, further comprising:
a position detector operative to detect the geographical location of said system; and wherein
said control module is operative to transmit data indicative of said geographical location with said retail information query.

40. A system for using product identifiers according to claim 39, wherein said retail information data includes data associated with at least one retailer within a predetermined distance of said geographical location.

41. A system for using product identifiers according to claim 38, wherein said control module is further operative to:
associate a purchase request with said product identifier and said retailer identifier responsive to instructions from said user; and
transmit said purchase request and said product identifier to said retailer identified by said retailer identifier.

42. A system for using product identifiers according to claim 41, wherein said control module is operative to transmit said purchase request query and said product identifier to said retailer via said data provider.

43. A system for using product identifiers according to claim 33, wherein:
said product identifier is a drug identifier identifying a drug; and
said selected query is a drug interaction query.

44. A system for using product identifiers according to claim 43, wherein said response includes drug interaction information associated with at least one drug interaction between said drug identified by said drug identifier and at least one other drug.

45. A system for using product identifiers according to claim 44, wherein said control module is further operative to transmit instructions to cause said data provider to store a record associating said drug associated with said drug identifier with said user.

46. A system for using product identifiers according to claim 43, wherein said control module is further operative to:
include a plurality of drug identifiers with said drug interaction query; and
transmit said plurality of drug identifiers and said drug interaction query to said data provider; and wherein
said response includes data indicative of at least one drug interaction between any combination of said drugs identified by said plurality of drug identifiers.

47. A system for using product identifiers according to claim 33, wherein:
said product identifier is a food identifier identifying a food product; and
said selected query is a food allergy query.

48. A system for using product identifiers according to claim 47, wherein said response includes at least one ingredient identifier associated with an ingredient of said food product, said ingredient associated with an allergy of said user by a record stored by said data provider.

49. A system for using product identifiers according to claim 33, wherein:
said user interface is further operative to receive at least one allergy ingredient identifier from said consumer; and
said control module is further operative to transmit instructions to associate said at least one allergy ingredient identifier with said user.

50. A system for using product identifiers according to claim 33, wherein:
said product identifier is a food identifier identifying a food product; and
said selected query is a food nutrition query.

51. A system according to claim 50, wherein said response includes data indicative of nutrition information associated with said food product.

52. A system for using product identifiers according to claim 33, wherein:
said product identifier is a food identifier identifying a food product; and
said selected query is a recipe query.

53. A system for using product identifiers according to claim 52, wherein said response includes data corresponding to at least one recipe therein, said recipe containing said food product as an ingredient.

54. A system for using product identifiers according to claim 33, wherein said control module is further operative to transmit said product identifier and said selected query to said data provider via a third party.

55. A system for using product identifiers according to claim 54, wherein said third party is a mobile telephone company.

56. A system for using product identifiers according to claim 33, further comprising a display operative to display the information contained in said response to said user.

57. A system for using product identifiers according to claim 56, wherein:
said user interface is further operative to receive a selection of at least one sort parameter from said user; and
said system further comprises a data sorter operative to sort said information contained in said response according to said sort parameter.

58. A system for using product identifiers according to claim 57, wherein:
said selected query is a retail information query;
said response includes data indicative of retail information associated with each of a plurality of retailers selling said product;
said retail information includes one or more of a price of said product associated with said product identifier, a location of said retailer selling said product, and a quantity of said product said retailer has on hand; and
said at least one sort parameter includes one or more of said price, said location, and said quantity.

59. A system for using product identifiers according to claim 58, further comprising:
a position detector operative to detect the geographical location of said system; and wherein
said at least one sort parameter includes said price and said location; and
said data sorter is operative to sort said information contained in said response by price and proximity to said geographical location of said system.

60. A system for using product identifiers according to claim 33, further comprising:
a local database including records associating a plurality of product identifiers with product information; and wherein
said control module is operative to transmit said product identifier and said selected query to said data provider by retrieving said local database from said data provider and submitting said selected query to said local database.

61. A system for using product identifiers according to claim 33, wherein said control module is further operative to store said response received from said data provider.

62. A system for using product identifiers according to claim 33, wherein:
said user interface is further operative to receive a storage command from said user; and
responsive to receipt of said storage command, said control module is further operative to transmit storage instructions to said data provider to cause said data provider to store a record associating said product identifier with said user.

63. A system for using product identifiers according to claim 33, wherein:
said user interface is further operative to receive a parameter from said user to at least partially define the content of said response; and
said control module is further operative to transmit said parameter to said data provider with said product identifier and said selected query.

64. A method for using product identifiers, said method comprising:
receiving a request from a consumer, said request including a unique product identifier captured by said consumer and data indicative of a type of information requested;
retrieving information corresponding to said type of information requested and associated with said particular product from a database; and
transmitting said retrieved information to said consumer.

65. A system for using a product identifier, said system comprising:
a network interface;
a capture device for capturing a product identifier identifying a product;
means for querying a data provider based on said captured product identifier; and
a display for displaying a response to said selected query received from said data provider via said network interface.

66. A computer-readable medium having stored therein a data structure comprising:
a first field containing data representing a captured product identifier; and
a second field containing data representing a predetermined query type.

67. A computer-readable medium according to claim 66, having stored therein a data structure further comprising:
a third field containing data representing a location of a mobile capture device that captured said product identifier.

68. A set of application program interfaces embodied on an electronically readable medium for execution on an electronic device in conjunction with a database that identifies information of interest to a consumer, comprising:
a first interface that receives a product identifier from a capture device;
a second interface that receives a query selection from a user; and
a third interface that transmits said product identifier and said query to said database.

69. In a computer system having a graphical user interface including a display and a selection device, a method of providing and selecting from a menu on the display, said method comprising:
retrieving a set of product information query identifiers, each of said product information query identifiers representing a particular type of information requested for a product identified by a product identifier;
displaying said set of product information query identifiers on said display;
receiving a signal indicative of said selection device acquainting with a selected one of said displayed product information query identifiers; and
submitting a query associated with said selected one of said displayed query identifiers to a database.
